(19) United States
(12) Patent Application Publication
(10) Pub. No.: US 2022/0083873 A1
(43) Pub. Date: Mar. 17, 2022

(54) Predictive Modeling of Well Performance Using Learning and Time-Series Techniques

(71) Applicant: Novi Labs, Inc., Austin, TX (US)

(72) Inventors: John Ramey, Austin, TX (US); Dillon Erik Niederhut, Austin, TX (US); Kyle David Crifasi, Austin, TX (US); Kristopher Nickolas Darnell, Austin, TX (US)

(21) Appl. No.: 17/387,766

(22) Filed: Jul. 28, 2021

Related U.S. Application Data
(60) Provisional application No. 63/079,924, filed on Sep. 17, 2020.

(51) Int. Cl. G06N 5/00; G06N 7/00; E21B 47/003

(52) U.S. Cl. CPC G06N 5/003; E21B 2200/22; E21B 47/003; G06N 7/005

(57) ABSTRACT

A system may include persistent storage containing training data related to well production, wherein entries in the training data respectively include time-independent input feature values and time-dependent input feature values both mapped to ground-truth production values of corresponding wells at particular points in time, wherein the time-dependent input feature values include ground-truth production values of the corresponding wells at respectively earlier points in time. The system may also include one or more processors configured to: train a decision-tree-based model with the training data; provide, to the decision-tree-based model, new time-independent input feature values and new time-dependent input feature values for a well; and receive, from the decision-tree-based model, one or more predicted production values of the well, wherein the one or more predicted production values are generated by the decision-tree-based model based on its internal structure, the new time-independent input feature values, and the new time-dependent input feature values.

### CROSS-REFERENCE TO RELATED APPLICATION

This application claims priority to U.S. provisional patent application No. 63/079,924, filed Sep. 17, 2020, which is hereby incorporated by reference in its entirety.

### BACKGROUND

Despite recent technological and economic advances in the fields of renewable energy, the world still obtains the majority of its energy needs from traditional fuels, such as oil and natural gas. Drilling new wells is a costly and time-consuming endeavor. Consequently, it is desirable to be able to model, understand, and predict the performance characteristics of these wells before drilling takes place. In this way, the time and money spent on well planning, drilling, and operational activities can be focused on higher productivity wells that exhibit lower drilling costs, lower operational costs, and increased operational safety. Further, even after wells have been drilled, it is still desirable to be able to accurately model, understand, and predict the future performance of these wells.

### SUMMARY

Onshore oil and/or natural gas deposits tend to be located in fields that can span up to millions of square miles. Often, multiple wells are drilled throughout various locations in a particular field. Despite their geographic proximity, these wells may exhibit different degrees of productivity, cost, and safety.

For instance, if two oil wells are drilled several miles apart from one another in the same field, one of these wells might outperform the other in terms of productivity and safety, while the other might have a lower cost. As an example, drilling through a softer rock might be less expensive than drilling through a harder rock, but might provide access to a smaller oil reserve.

When determining where to locate a third well, it would be ideal to determine, if possible, a location that combines the productivity and safety characteristics of the first well with the cost characteristics of the second well. However, well location is not the only factor. Other features of the wells, such as diameter, depth, slant, lateral length, drilling equipment, stimulation, and so on can also play a role. Notably, dozens of geological, hydrological, mechanical, and procedural factors can be identified that may influence the productivity, cost, and safety of a particular well. Some of these factors may have a strong influence on productivity, cost, and safety, while others may have little or no influence.

Therefore, it may be beneficial to identify which of these input features have the strongest impact on the output characteristics of wells. With this knowledge, new wells can be drilled and operated with greater productivity, lower cost, and/or higher safety.

Furthermore, operational data from existing wells can be used to improve the predictive ability of models that are otherwise based on static parameters. This operational data may result in some features that were previously static becoming dynamic (e.g., lateral distance to nearest well, production volume). In this fashion, the operational data can provide new information that is learned over the course of well production. Thus, introducing these time-dependent features to the models may make predictions of future well performance more accurate.

Additionally, incorporation of the time-dependent features also allow determination of counterfactual scenarios and forecasts. Such a scenario may involve well operational data that includes the point at which production was dramatically reduced due to some event (e.g., operator error, broken equipment, or nearby wells coming online). The models herein can answer the question of what would production have been if the event had not happened. Conversely, another scenario might involve operational data without such an event being used to predict the impact on production if the event had occurred. In either case, the difference between actual and predicted production can be determined.

The embodiments herein provide a combined approach that is the first that can be used for both predictive pre-drilling operations, as well as predictive and explanatory post-drilling operations. This single, generalized model is more flexible, accurate and applicable than existing models.

Accordingly, a first example embodiment may involve persistent storage containing training data related to well production, wherein entries in the training data respectively include time-independent input feature values and time-dependent input feature values both mapped to ground-truth production values of corresponding wells at particular points in time, wherein the time-dependent input feature values include ground-truth production values of the corresponding wells at respectively earlier points in time. The first example embodiment may also involve one or more processors configured to: obtain, from the persistent storage, the training data; train a decision-tree-based model with the training data; provide, to the decision-tree-based model, new time-independent input feature values and new time-dependent input feature values for a well; receive, from the decision-tree-based model, one or more predicted production values of the well, wherein the one or more predicted production values are generated by the decision-tree-based model based on its internal structure, the new time-independent input feature values, and the new time-dependent input feature values; and write, to the persistent storage, the one or more predicted production values.

A second example embodiment may involve obtaining, from persistent storage, training data related to well production, wherein entries in the training data respectively include time-independent input feature values and time-dependent input feature values both mapped to ground-truth production values of corresponding wells at particular points in time, wherein the time-dependent input feature values include ground-truth production values of the corresponding wells at respectively earlier points in time. The second example embodiment may also involve training a decision-tree-based model with the training data. The second example embodiment may involve providing, to the decision-tree-based model, new time-independent input feature values and new time-dependent input feature values for a well. The second example embodiment may involve receiving, from the decision-tree-based model, one or more predicted production values of the well, wherein the one or more predicted production values are generated by the decision-tree-based model based on its internal structure, the new time-independent input feature values, and the new time-dependent input feature values. The second example embodiment may involve writing, to the persistent storage, the one or more predicted production values.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include one or more processors, as well as memory and program instructions. The program instructions may be stored in the memory, and upon execution by the one or more processors, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a high-level depiction of well similarity analysis, according to an example embodiment.

FIG. 2 illustrates a schematic drawing of a computing device, according to an example embodiment.

FIG. 3 illustrates a schematic drawing of a networked server cluster, according to an example embodiment.

FIGS. 4A and 4B provide a list of input features related to well drilling and/or operation, according to an example embodiment.

FIG. 4C provides another list of input features related to well drilling and/or operation, along with priorities and data types thereof, according to an example embodiment.

FIG. 5A is a partial decision tree, according to an example embodiment.

FIG. 5B is a decision tree, according to an example embodiment.

FIG. 6 depicts a sliding window for predicting well production based on various time periods, according to an example embodiment.

FIG. 7 depicts AR(1) production data integrated into a well production prediction model, according to an example embodiment.

FIG. 8 depicts AR(2) production data integrated into a well production prediction model, according to an example embodiment.

FIGS. 9A, 9B, 9C, and 9D depict making recursive predictions of future well production, according to an example embodiment.

FIG. 10 depicts graphs of an anomalous event, according to an example embodiment.

FIGS. 11A and 11B depict modeling counterfactual events, according to an example embodiment.

FIG. 12 depicts time-dependent data integrated into a well production prediction model, according to an example embodiment.

FIG. 13 depicts a graphical user interface representing associations between input features and well production, in accordance with an example embodiment.

FIG. 14 is a flow chart, in accordance with an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

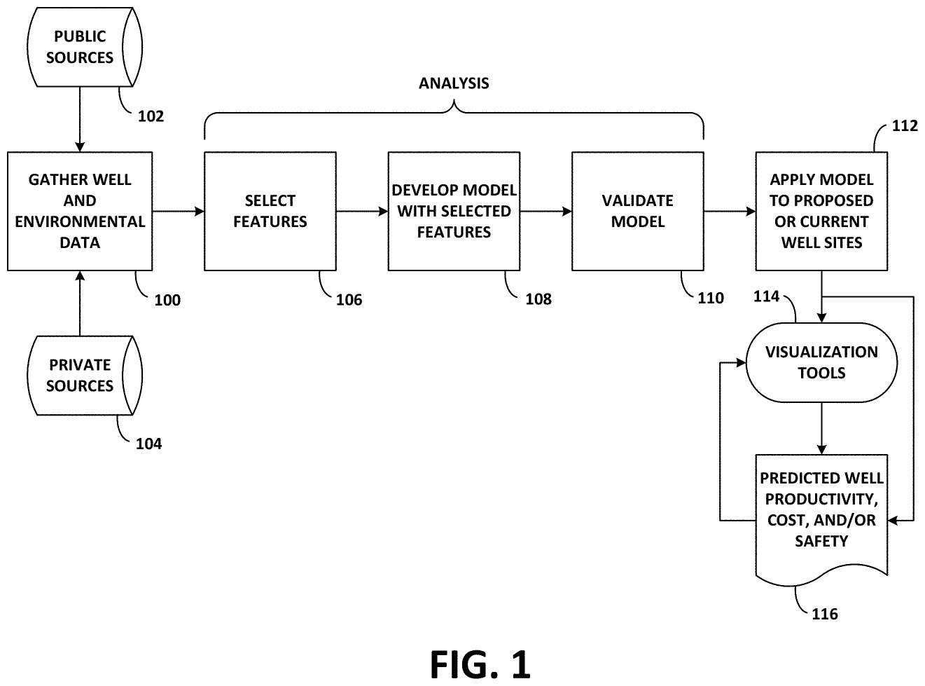

FIG. 1 is a depiction of an example well similarity analysis procedure. By following this procedure, the output characteristics of one or more proposed or existing well sites may be predicted. The type of well described herein is typically an oil or gas well located in an onshore/on-land location, but the present embodiments may be used with other types of wells, including those in offshore/deep water locations.

At step 100, well and environmental information is gathered. As shown in FIG. 1, this information may be gathered from public sources 102 and/or private sources 104. For instance, public sources may include federal, state, and local government data, such as geological survey data, and well information reported to regulatory bodies. Private sources may include data gathered by entities that drill and/or own wells in the general vicinity of the proposed well sites. This information may include pre-drill data, which largely or entirely represents static data such as well length and geological characteristics. This information may also include post-drill operational data, such a distance to nearby wells and well production. However, other data may also be gathered. Each of these pre-drill and post-drill characteristics may be referred to as a “feature” of a well, regardless of whether that well is proposed or existing.

At step 106, input features are selected. The feature selection process, which is detailed in the following sections, involves identifying input features of the gathered data, and selecting those that are likely to have the most significant impact on the output characteristics of wells drilled at the proposed sites. Of the input features, some may have little or no impact on well output characteristics, while others may have a significant impact on well output characteristics.

Well output characteristics include well productivity (e.g., barrels of oil over a particular period of time), well costs (e.g., drilling cost and/or ongoing operational costs), and/or well safety (e.g., frequency and/or severity of injuries during well drilling and/or operation). However, other output characteristics may be used instead of or in addition to those described above.

In order to select input features, a comparison between the values of some or all input features and the values of output characteristics of a particular set of wells may be made. The wells in this set may be randomly chosen. The comparison may involve some form of regression analysis, such as an autoregressive technique. Example analytical tools include, but are not limited to, decision trees, random forests, gradient-boosted trees, extremely randomized trees, support vector machines, and neural networks. Regardless of the analytical tool employed, the goal of the analysis is to determine which input features have the most significant impact on the well output characteristics. In order to simplify the analysis, the number of features selected should be smaller than the number of total features, perhaps one-quarter to one-tenth as many.

A separate analysis and feature selection step may be performed for each output characteristic. Thus, for example, if the output characteristics of interest are well productivity and well cost, step 106 may be performed twice, and different sets of features may be selected each time.

At step 108, a model of well output characteristics may be developed based on the features selected in step 106. This model may predict one or more output characteristics of a proposed well site, based on the values of the input features associated with these features. If multiple output characteristics are of interest, separate models for each may be developed.

At step 110, the model(s) may be validated. One way of doing so is to test the model against the output characteristics of an actual well site that was not used to develop the model. For instance, in a given oil field of 100 wells, 75 may be randomly chosen as training data for the model of step 108. Once the model is developed, it may be tested against the remaining 25 wells.

For a given output characteristic, the value predicted by the model may be compared to the actual value exhibited by the well. The difference between these values is considered error, and may be expressed as an absolute error. Over the remaining 25 wells, the aggregate error may be characterized as the total absolute error, mean squared error, root mean squared error, median error, or in some other fashion. If the aggregate error is sufficiently small (e.g., less than a particular value or less than the aggregate error produced by another model), the modeling may be considered a success, and the model may be considered validated.

At step 112, a validated model may be applied to proposed well sites. Application of the validated model may result in predicted well output characteristics 116 for each proposed site. Thus, the model may help determine where to purchase land and/or mineral rights to land, as well as where and how to drill wells on this land. In some cases, visualization tools 114 may be used in order to allow a user to change the values of one or more input features for a proposed well site, and see how these changes impact well output characteristics.

Additional techniques, steps and procedures may be used within the framework of FIG. 1. Thus, FIG. 1 is for purposes of illustration and should not be considered limiting.

### II. Example Computing Devices and Cloud-Based Computing Environments

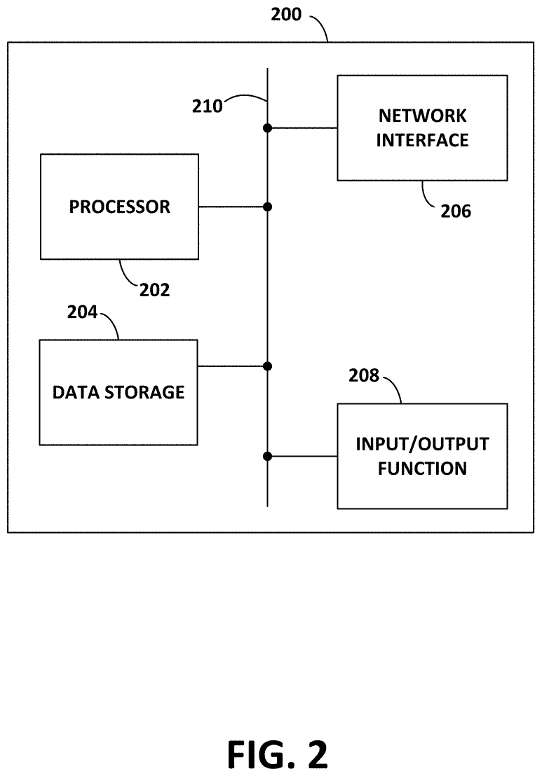

FIG. 2 is a simplified block diagram exemplifying a computing device 200, illustrating some of the functional components that could be included in a computing device arranged to operate in accordance with the embodiments herein. Example computing device 200 could be a personal computer (PC), laptop, server, or some other type of computational platform. For purposes of simplicity, this specification may equate computing device 200 to a server from time to time, and may also refer to some or all of the components of computing device 200 as a “processing unit.” Nonetheless, it should be understood that the description of computing device 200 could apply to any component used for the purposes described herein.

In this example, computing device 200 includes a processor 202, a data storage 204, a network interface 206, and an input/output function 208, all of which may be coupled by a system bus 210 or a similar mechanism. Processor 202 can include one or more CPUs, such as one or more general purpose processors and/or one or more dedicated processors (e.g., application specific integrated circuits (ASICs), graphical processing units (GPUs), digital signal processors (DSPs), network processors, etc.).

Data storage 204, in turn, may comprise volatile and/or non-volatile data storage and can be integrated in whole or in part with processor 202. Data storage 204 can hold program instructions, executable by processor 202, and data that may be manipulated by these instructions to carry out the various methods, processes, or functions described herein. Alternatively, these methods, processes, or functions can be defined by hardware, firmware, and/or any combination of hardware, firmware and software. By way of example, the data in data storage 204 may contain program instructions, perhaps stored on a non-transitory, computer-readable medium, executable by processor 202 to carry out any of the methods, processes, or functions disclosed in this specification or the accompanying drawings.

Network interface 206 may take the form of a wireline connection, such as an Ethernet, Token Ring, or T-carrier connection. Network interface 206 may also take the form of a wireless connection, such as IEEE 802.11 (Wifi), BLUETOOTH®, or a wide-area wireless connection. However, other forms of physical layer connections and other types of standard or proprietary communication protocols may be used over network interface 206. Furthermore, network interface 206 may comprise multiple physical interfaces.

Input/output function 208 may facilitate user interaction with example computing device 200. Input/output function 208 may comprise multiple types of input devices, such as a keyboard, a mouse, a touch screen, and so on. Similarly, input/output function 208 may comprise multiple types of output devices, such as a screen, monitor, printer, or one or more light emitting diodes (LEDs). Additionally or alternatively, example computing device 200 may support remote access from another device, via network interface 206 or via another interface (not shown), such as a universal serial bus (USB) or high-definition multimedia interface (HDMI) port.

In some embodiments, one or more computing devices may be deployed in a networked architecture. The exact physical location, connectivity, and configuration of the computing devices may be unknown and/or unimportant to client devices. Accordingly, the computing devices may be referred to as “cloud-based” devices that may be housed at various remote locations.

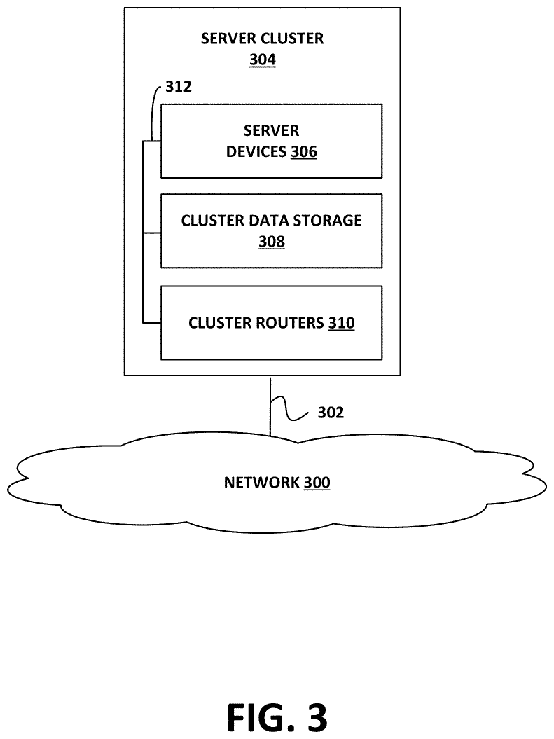

FIG. 3 depicts a cloud-based server cluster 304 in accordance with an example embodiment. In FIG. 3, functions of computing device 200 may be distributed between server devices 306, cluster data storage 308, and cluster routers 310, all of which may be connected by local cluster network 312. The number of server devices, cluster data storages, and cluster routers in server cluster 304 may depend on the computing task(s) and/or applications assigned to server cluster 304.

For example, server devices 306 can be configured to perform various computing tasks of computing device 200. Thus, computing tasks can be distributed among one or more of server devices 306. To the extent that these computing tasks can be performed in parallel, such a distribution of tasks may reduce the total time to complete these tasks and return a result.

Cluster data storage 308 may be data storage arrays that include disk array controllers configured to manage read and write access to groups of hard disk drives and/or solid state drives. The disk array controllers, alone or in conjunction with server devices 306, may also be configured to manage backup or redundant copies of the data stored in cluster data storage 308 to protect against disk drive failures or other types of failures that prevent one or more of server devices 306 from accessing units of cluster data storage 308.

Cluster routers 310 may include networking equipment configured to provide internal and external communications for the server clusters. For example, cluster routers 310 may include one or more packet-switching and/or routing devices configured to provide (i) network communications between server devices 306 and cluster data storage 308 via cluster network 312, and/or (ii) network communications between the server cluster 304 and other devices via communication link 302 to network 300.

Additionally, the configuration of cluster routers 310 can be based at least in part on the data communication requirements of server devices 306 and cluster data storage 308, the latency and throughput of the local cluster network 312, the latency, throughput, and cost of communication link 302, and/or other factors that may contribute to the cost, speed, fault-tolerance, resiliency, efficiency and/or other design goals of the system architecture.

As noted, server devices 306 may be configured to transmit data to and receive data from cluster data storage 308. This transmission and retrieval may take the form of SQL queries or other types of database queries, and the output of such queries, respectively. Additional text, images, video, and/or audio may be included as well. Furthermore, server devices 306 may organize the received data into web page or web application representations. Such a representation may take the form of a markup language, such as the hypertext markup language (HTML), the extensible markup language (XML), or some other standardized or proprietary format. Moreover, server devices 306 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® or other languages may be used to facilitate generation of web pages and/or to provide web application functionality.

### III. Example Well Input Features and Well Output Characteristics

As discussed above, a well may have various input features that influence its output characteristics. In this section an overview of oil well drilling is provided, and examples of input features and output characteristics are introduced. This process may be similar, to some extent, to processes used for drilling other types of wells.

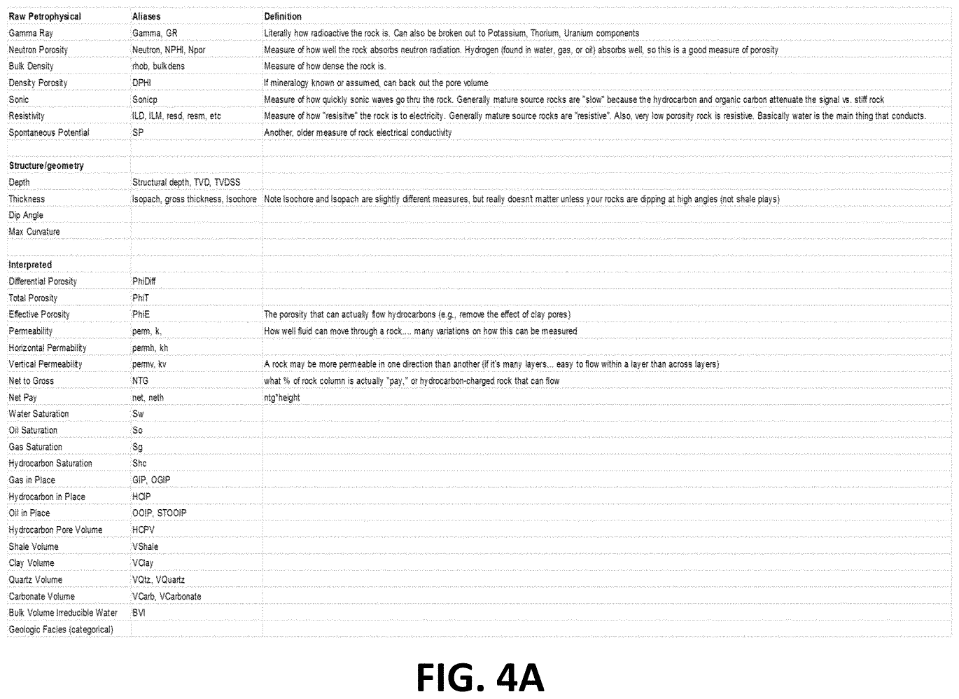

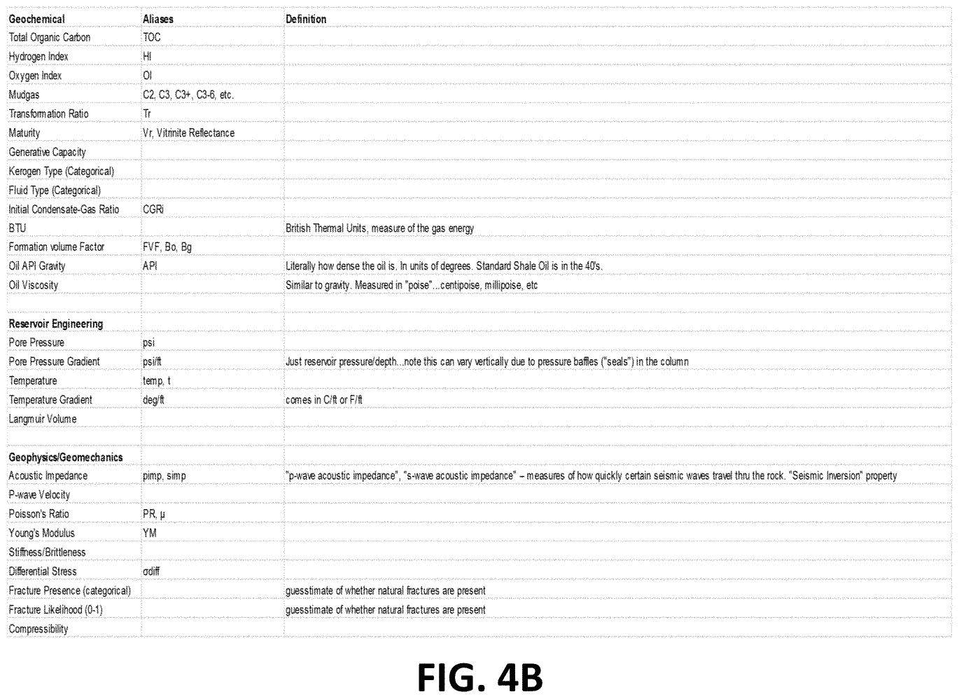

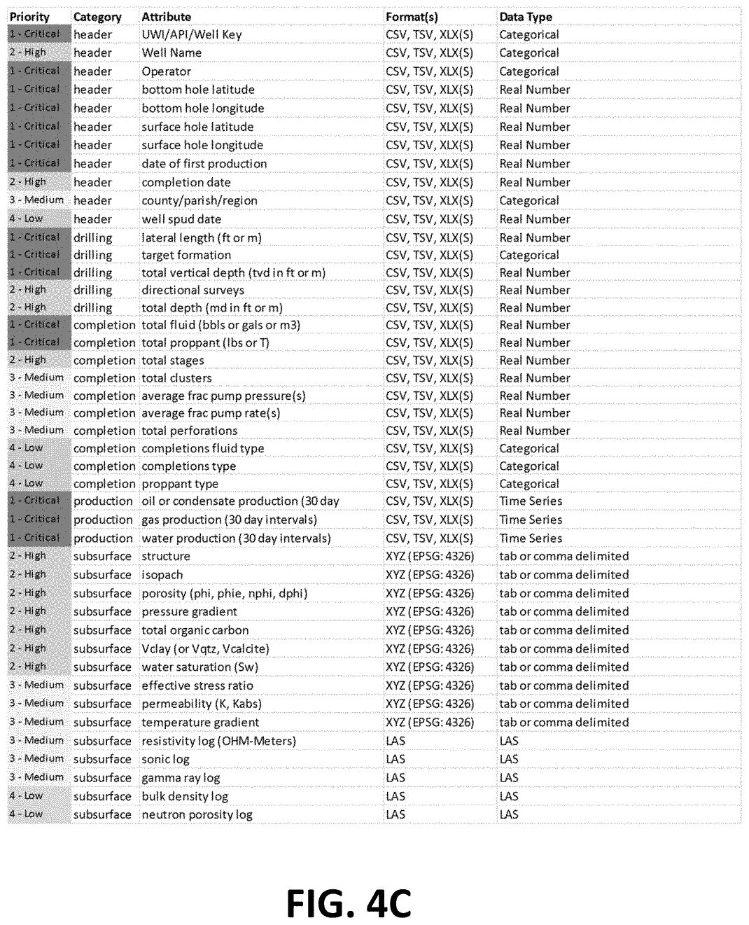

Further examples of possible geological input features broken out by category are provided in FIGS. 4A and 4B. In these figures, each feature is named, a shorthand alias is provided where applicable, and the feature is defined where applicable. FIG. 4C provides another such list, this time with example priorities and data types of each. The priorities may indicate how important each feature is to modeling efforts, while data types indicate how the feature is expected to be represented. There may be overlap between the input features in FIGS. 4A and 4B, those of FIG. 4C, and the input features described below.

A. Well Drilling Overview

Sites are selected for drilling via a well planning process typically conducted by teams of geoscience experts. These teams may evaluate quantities of data, drill test wells to learn about the nature of the underlying geology, and/or attempt to make determinations about the performance potential of each well drilled. To optimize efficiency of drilling activities, multiple drilling operations in the same area are often contemplated so that they can be coordinated and executed in parallel subsequent operations.

A well may be created by drilling a hole into the earth with a drilling rig. The hole may be 5 to 50 inches in diameter, but narrower or wider holes may be drilled. The hole might not be drilled straight down. For many wells, holes are drilled laterally or horizontally.

To drill the hole, a drilling rig rotates a drill pipe with a bit attached. As or after the hole is drilled, sections of steel casings may be placed into the hole. Concrete may also be placed between the outside of the casing and the hole. The casing and concrete provide structural stability for the well.

With the hole protected by the casing and concrete, the well may be drilled deeper with a smaller bit, possibly within a smaller casing. This process may repeat a number of times, with the hole being drilled by progressively smaller bits inside of narrower casings.

The drill bit, possibly aided by the weight of drill collars above it, either slices into the rock or otherwise breaks the rock down into smaller pieces. Drilling fluid, sometimes called “mud,” may also be pumped into the drill pipe to cool the drill bit as well as to normalize the pressure differential between the hole and the surrounding rock. The rock pieces cut by the bit may be brought to the surface outside of the drill pipe.

After the well is drilled and cased, it may be completed so that it can produce and recover hydrocarbons. Small holes, sometimes referred to as “perforations” may be made in the casing at a depth at which the oil reservoir exists. These provide a path for the hydrocarbons to flow from the surrounding rock, up the well shaft, and to the surface. In some wells, the pressure of the hydrocarbon reservoir is high enough for the hydrocarbons to flow to the surface. However, if this is not the case, artificial lift methods can be used to force hydrocarbons out of the ground.

In some cases, fissures in formations of hard rock surrounding the well can be created by hydraulically injecting water, sand, and/or chemicals into the rock. When the hydraulic pressure is removed from the well, small grains of proppant (e.g., sand or aluminum oxide) may be used to hold the fissures. This process is known as “stimulation” and may take place in multiple stages. In this way, hydrocarbons that otherwise would be inaccessible might become available for production.

B. Input Features

Input features are typically aspects of a particular well's location, physical traits, and the drilling processes that were used to form the well. These features may include, but are not limited to, the following:

Date of stimulation: The date that a particular well formation was stimulated via an injection process.

Spud date: The date that a particular well was spud for drilling. The term “spud” in the art of well drilling may refer to the very start of drilling.

Stimulated formation: The geological name of the formation where the stimulation took place. For example, the shale deposit in the northwestern part of North Dakota may be referred to as the “Bakken” formation. Within that formation, there are multiple layers, typically referred to individually as a “shelf.” Each shelf within the formation also typically has a reference name, such as “Middle Bakken,” “Upper Bakken,” or “Three Forks.”

Average porosity: The average projected porosity of the rock in the stimulated formation (e.g., between 0% and 100%).

Stimulation stages: The total number of stimulations done along the lateral length of a particular well during the drilling and completion process.

Fluid system type: The type of fluid utilized during the drilling and completion process of a particular well.

Sleeve stages: The type of sleeves (e.g., casings) that were used during the drilling and completion process of a particular well.

Maximum treatment pressure: The maximum pressure achieved during the drilling and completion process of a particular well.

Operator: The current operator of a particular well. For example, the corporation, or other entity that is in charge of the drilling and/or production of the well.

Water saturation: An estimated measure of the amount of water discovered among the hydrocarbons recovered for a particular well. Water saturation can be expressed either as an absolute amount (e.g., a number of gallons) or a percentage of fluids recovered (e.g., 3%, 5%, etc.).

Proppant type: The type of material used in the proppant mixture during the drilling and completion process of a particular well.

Ceramic volume: The volume of ceramic material utilized during the drilling and completion process of a particular well.

Completion type: The method for completion used during the drilling and completions process of a particular well (e.g., perforations made in the casings, etc.).

Oil viscosity: A measure of the density of oil hydrocarbons recovered from a particular well.

Longitude: A reference to the precise geographic location of a particular well.

Latitude: A reference to the precise geographic location of a particular well.

Elevation: The distance above sea level at which drilling began for a particular well.

Equipment type: The type of drilling equipment used to drill a particular well. This input feature may take the form of a list of equipment, and may include make and model names/numbers for each piece of equipment in the list.

Days after initial production (IP day): The number of days that have passed since production began on the well (e.g., 30, 60, 90, etc.).

Nearest well: The lateral distance between the well and its nearest neighboring well.

Choke: A device, typically a manipulable bore aperture, that is used to control the flow rate or system pressure of a well. Chokes may be adjustable or fixed.

Wellbore pressure: The force exerted per unit area (e.g., pounds per square inch) by the well. This could be wellhead pressure (measured at the top of the wellbore), bottom-hole pressure (measured at the bottom of the wellbore), line pressure, casing pressure, etc.

Pore pressure: The force exerted per unit area (e.g., pounds per square inch) in the pore spaces of rock adjacent to or nearby a well.

Artificial lift: Several methods that can be used to lower the producing pressure to obtain a higher production rate from the well.

Lagged production (n days ago): The volume produced by a well n days in the past. While these values are derived from production-related output characteristics (such as well productivity defined below), they can be fed back into the model as autoregressive input features.

Anomalous events: These features include any sort of anomaly that may have impacted production of a well in the given time period. Such events may be represented as Boolean values (i.e., an anomaly occurred or it did not), or other types of values more directly representing different types of anomalies. Example anomalies include a frac hit on a nearby well (where the pumping of a hydraulic fracturing treatment in the nearby well causes a reduction of production in the current well), adverse weather events, human error, and so on.

C. Output Characteristics

Output characteristics are typically aspects of a particular well's performance after substantive drilling is complete and the well is producing. These output characteristics may include, but are not limited to, the following:

Well productivity: the amount of hydrocarbons produced by the well over a given period of time. This characteristic is often measured in barrels, and the period of time may be 30 days, 60 days, 90 days, 120 days, 180 days, or some other range.

Well cost: the extent of money and/or resources spent to drill the well and/or operate the well over a period of time. Well cost may include real estate, mineral rights, machinery, geophysical survey, raw materials, and/or personnel costs. The period of time may be 30 days, 60 days, 90 days, 120 days, 180 days, or some other range.

Well safety: This characteristic may be measured in various ways, but is typically an indication of the number of injuries to well-operations personnel, and/or severity of those injuries, over a period of time. For instance, injuries may be classified as minor (resulting in no missed days of work), major (resulting in one or more missed days of work), or catastrophic (resulting in death). The period of time may be 30 days, 60 days, 90 days, 120 days, 180 days, or some other range.

Condensate gas ratio (CGR): A measure of the liquid content in hydrocarbons.

Gas oil ratio (GOR): A high GOR implies that a well is producing relatively little oil, which is usually undesirable.

Water oil ratio (WOR): A high WOR may indicate an influx of water into a well, possibly due to a nearby frac hit.

Terminal decline: The span of time in the life of a well where the rate of production decline stops changing. In other words, production from a well decreases over time, and the rate of decrease also decreases, so terminal decline is when the second derivative is around zero. Predictions may be made for when terminal decline begins, and the final, stable, rate of decline.

### IV. Example Feature Selection and Learning Model Development

In this section an example of feature selection and learning model development is provided. For purposes of illustration and simplicity, only three input features and one output characteristic are considered, and the data set is small. In practice, many more input features, output characteristics, and data set entries may be used. Further, the values of input features and output characteristics used in this example were chosen for convenience and may not represent the values exhibited in actual wells. Thus, this example should be considered a non-limiting illustration.

Also, this example uses a feature selection technique known as a decision tree. Other learning techniques, such as random forests, gradient-boosted trees, extremely randomized trees, support vector machines, and/or neural networks may also be used. A decision tree is a branching arrangement of questions about input data that, when answered, result in a prediction of a characteristic of the input data. Thus, a decision tree could be used as a classifier, for example. Each question may relate to a particular input feature, and the answer may be based on the value of this input feature.

In short, a decision tree maps the values of input features to values of output characteristics using a tree-like structure. Branching points can be found in a greedy fashion based on the entropy or Gini index of the training data. Branches that are most likely to direct the traversal toward relevant features (features that have more impact on the output characteristics) are placed higher in the tree. In practical embodiments, the depth, number of splits per node, or total number of leaf nodes may be constrained so that each tree is more tractable. Decision trees can be constructed in an iterative or recursive fashion.

Using randomization or by varying parameters, multiple decision trees may be generated for a given data set (e.g., a random forest or gradient-boosting model as noted above). As an example, results from subsets of the decision trees may be added together so that a loss function is minimized. After calculating the loss function for a given subset of tree, a gradient descent procedure is invoked to add a new tree to the model that reduces the loss (i.e., follows the gradient). This can be accomplished by parameterizing the tree, then modifying the parameters of the tree and moving in the right direction by reducing the residual loss.

TABLE 1
Training Well Data (First Iteration).

| | | | Initial | 90-Day |
|---|---|---|---|---|
| Training | Stimulation | Depth | Reservoir | Production |
| Well | Stages | (feet) | Pressure (PSI) | (Barrels) |
| A | 20 | 5,000 | 50 | 30,000 |
| B | 15 | 4,500 | 45 | 27,000 |
| C | 18 | 5,100 | 35 | 26,000 |
| D | 10 | 5,500 | 30 | 20,000 |
| E | 25 | 5,300 | 33 | 35,000 |
| F | 17 | 5,200 | 37 | 18,000 |

Putting these notions into practice, Table 1 provides example training well data. For each well (A, B, C, D, E, and F), input features are provided (the number of stimulation stages, the depth of the well in feet, and the initial reservoir pressure (pressure) in pounds per square inch (PSI)), and an output characteristic is provided (the well's actual 90-day oil production in barrels). This training well data may be used to predict the 90-day production of proposed wells based on the input characteristics of the proposed wells.

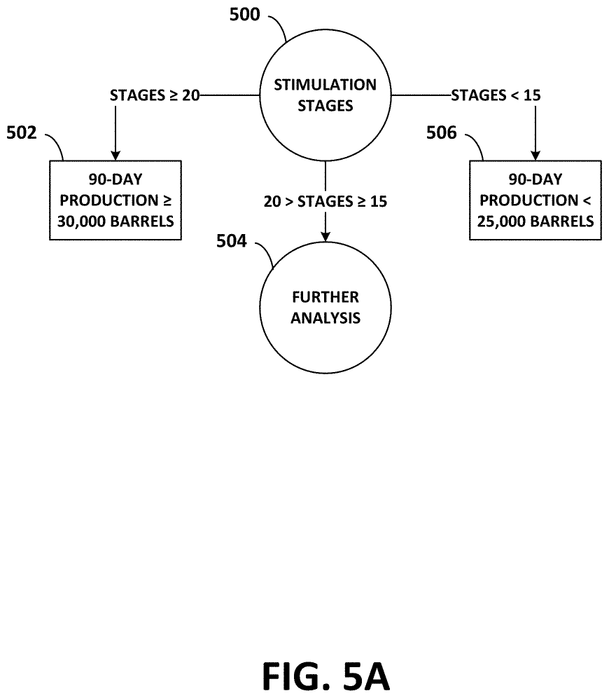

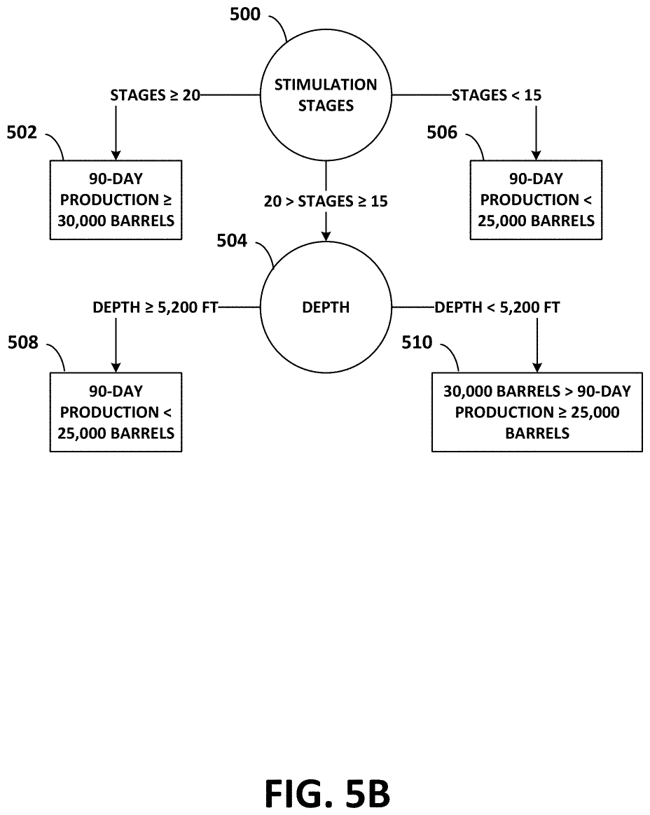

In order to make these predictions, a decision tree can be constructed in an iterative (or recursive) fashion. In short, a decision tree maps the values of input features to values of output characteristics using a tree-like structure. An example of a decision tree for the training well data is shown in FIG. 5B, and this section explains how the tree is built and used.

Since the input features and output characteristics are not limited to a small number of discrete values, the range for each of the input factor and output characteristic values is divided into “buckets.” Each bucket represents a subset of the observed range for its respective input factor or output characteristic. The buckets for each input feature and output characteristic discussed herein were chosen for purposes of convenience. In practice, different arrangements of buckets may be used, and the ranges for buckets may be chosen in a methodical fashion.

TABLE 2
90-Day Production Buckets (First Iteration).

| 90-Day Production Buckets | Bucket Contents (Wells) | | Probability |
|---|---|---|---|
| prod ≥ 30,000 (X) | 2 | (A, E) | 0.333 |
| 30,000 > prod ≥ 25,000 (Y) | 2 | (B, C) | 0.333 |
| 25,000 > prod (Z) | 2 | (D, F) | 0.333 |

The buckets for 90-day production are shown in Table 2. In this table, 90-day production is divided into three buckets: wells that produce 30,000 barrels or more in their first 90 days, wells that produce from 25,000 up to 30,000 barrels in their first 90 days, and wells that produce less than 25,000 barrels in their first 90 days. These buckets are labeled with the shorthand representations X, Y, and Z, respectively.

In each bucket are two wells, as indicated in the second column. In the third column the probability of any of the 6 wells falling into each bucket is given. Since there are two wells in each bucket, this probability is 2/6=0.333 for each bucket. Note that for Table 2, and throughout this section, all decimal values are rounded to the nearest thousandth.

One can measure the extent to which the data in Table 2 is skewed by determining, for example, its entropy or its Gini index. Such a measurement may be used throughout this example to determine the impact that each input factor has on 90-day production.

The entropy of a data set is given by the equation:

$$e = {\sum }_{i} - {p}_{i} {log}_{2} ( {p}_{i} )$$

Here, pᵢ is the probability of a particular outcome. Thus, for the data of Table 2, the entropy is:

e=−0.333 log₂(0.333)−0.333 log₂(0.333)−0.333 log₂(0.333)=1.585

The Gini index of a data set is given by the equation:

$$g = 1 - {\sum }_{i} {p}_{i}^{2}$$

Thus, for the data of Table 2, the Gini index is:

g=1−(0.333)²−(0.333)²−(0.333)²=0.667

The higher the entropy and the Gini index, the less skewed (more evenly distributed), and therefore uncertain, the data. Note that for a data set with only one value that can be output, both the entropy and the Gini index is 0. In practice, either the entropy or the Gini index need be used for a given analysis. However, in order to illustrate the variety of ways in which this analysis can be performed, the example herein will use both. Nonetheless, other measures of uncertainty, such as Classification Error, variance, and residual sum of squares may be used instead of entropy and Gini index.

The next step in building the decision tree is to determine the impact of each input factor on the 90-day production of a well. Table 3, Table 4, and Table 5 illustrate this step.

TABLE 3
Stimulation Stages Buckets (First Iteration).

| Stimulation | Bucket | | 90-Day | | |
|---|---|---|---|---|---|
| Stages | Contents | | Production | | Gini |
| Buckets | (Wells) | | Buckets | Entropy | Index |
| stages ≥ 20 | 2 | (A, E) | X | 0 | 0 |
| 20 > stages ≥ 15 | 3 | (B, C, F) | Y, Y, Z | 0.923 | 0.456 |
| 15 > stages | 1 | (D) | Z | 0 | 0 |

In Table 3, the stimulation stages are divided into three buckets: 20 or more, at least 15 but less than 20, and less than 15. Two wells, A and E, fall into the first bucket, three wells, B, C, and F, fall into the second bucket, and one well, D, falls into the third bucket.

Notably, all wells that fall into the first bucket also fall into 90-day production bucket X, and all wells that fall into the third bucket also fall into 90-day production bucket Z. Therefore, for this data, the number of stimulation stages used in drilling a well is strongly correlated with the 90-day production of the well, and may be a predictor thereof. To that point, the entropy and the Gini index for the first and third buckets are both 0.

On the other hand, wells that fall into the second bucket may fall into either 90-day production bucket Y or 90-day production bucket Z. Twice as many wells fall into 90-day production bucket Y as 90-day production bucket Z, so the probability that a well that falls into the second bucket also falls into 90-day production bucket Y is 0.667, and the probability that a well that falls into the second bucket also falls into 90-day production bucket Z is 0.333.

Therefore, the entropy and Gini index of the second bucket are given by:

e=−0.333 log₂(0.333)−0.667 log₂(0.667)=0.923g=1−(0.333)²−(0.667)²=0.456

Based on these results, the average entropy and average Gini index for all buckets in Table 3 can be calculated as:

ē=2/6(0)+3/6(0.923)+1/6(0)=0.462

g̅=2/6(0)+3/6(0.456)+1/6(0)=0.228

The average entropy and average Gini index for a given input factor represents the extent that the relationship between the given input factor and the 90-day production output characteristic is skewed. The lower the average entropy and average Gini index, the less skewed the relationship, and the given input factor is a better predictor of the 90-day production output characteristic.

TABLE 4
Depth Buckets (First Iteration).

| | Bucket | | 90-Day | | |
|---|---|---|---|---|---|
| Depth | Contents | | Production | | Gini |
| Buckets | (Wells) | | Buckets | Entropy | Index |
| depth ≥ 5200 | 3 | (D, E, F) | X, Z, Z | 0.923 | 0.456 |
| 5200 > depth ≥ 4700 | 2 | (A, C) | X, Y | 1 | 0.5 |
| 4700 > depth | 1 | (B) | Y | 0 | 0 |

This process is repeated for the well depth and pressure input features. In Table 4, depths are divided into three buckets: 5200 feet or more, at least 4700 feet but less than 5200 feet, and less than 4700 feet. Three wells, D, E, and F, fall into the first bucket, two wells, A and C, fall into the second bucket, and one well, B, falls into the third bucket.

All wells that fall into the third bucket also fall into 90-day production bucket Y. Thus, the entropy and the Gini index for the third bucket are both 0. However, wells that fall into the first and second buckets may fall into 90-day production buckets X or Z, and X or Y, respectively.

The entropy and Gini index of the first bucket are given by:

e=−0.333 log₂(0.333)−0.667 log₂(0.667)=0.923

g=1−(0.333)²−(0.667)²=0.456

The entropy and Gini index of the second bucket are given by:

e=−0.5 log₂(0.5)−0.5 log₂(0.5)=1

g=1−(0.5)²−(0.5)²=0.5

Based on these results, the average entropy and average Gini index for all buckets in Table 4 can be calculated as:

ē=3/6(0.923)+2/6(1)+1/6(0)=0.8

g̅=3/6(0.456)+2/6(0.5)+1/6(0)=0.4

The average entropy and average Gini index for depth are both higher than the average entropy and average Gini index for stimulation stages. This indicates that, for this data set, the number of stimulation stages of a well is more likely to be predictive of 90-day production of the well than the depth of the well.

TABLE 5
Pressure Buckets (First Iteration).

| | Bucket | | 90-Day | | |
|---|---|---|---|---|---|
| Pressure | Contents | | Production | | Gini |
| Buckets | (Wells) | | Buckets | Entropy | Index |
| pressure ≥ 40 | 2 | (A, B) | X, Y | 1 | 0.5 |
| 40 > pressure | 4 | (C, D, E, F) | X, Y, Z, Z | 1.5 | 0.625 |

Table 5 shows how wells are divided into buckets based on their pressure. For this input factor, there are two buckets: 40 PSI or more, and less than 40 PSI. Two wells, A and B, fall into the first bucket, and the remaining four wells, C, D, E, and F, fall into the third bucket.

The entropy and Gini index of the first bucket are given by:

e=−0.5 log₂(0.5)−0.5 log₂(0.5)=1

g=1−(0.5)²−(0.5)²=0.5

The entropy and Gini index of the second bucket are given by:

e=−0.25 log₂(0.25)−0.25 log₂(0.25)−0.5 log₂(0.5)=1.5

g=1−(0.25)²−(0.25)²−(0.5)²=0.625

Based on these results, the average entropy and average Gini index for all buckets in Table 5 can be calculated as:

ē=2/6(1)+4/6(1.5)=1.333

g̅=2/6(0.5)+4/6(0.625)=0.583

The average entropy and average Gini index for pressure are both higher than the average entropy and average Gini indexes for stimulation stages and depth. Therefore, the number of stimulation stages has the lowest entropy and Gini index of the three input features. This indicates that, for this data set, the number of stimulation stages of a well is more likely to be predictive of 90-day production of the well than the depth or pressure of the well. Consequently, the number of stimulation stages is chosen as the root node of the decision tree.

The decision tree represents a decision-making process that can be followed to estimate the 90-day production of proposed wells. A partial decision tree for the data set is shown in FIG. 5A. Root node 500 indicates that the number of stimulation stages is the first input factor to be considered. If the number of stages for a proposed well is greater than or equal to 20, the decision tree indicates, at leaf node 502, that the 90-day production of the proposed well is likely to be greater than or equal to 30,000 barrels. On the other hand, if the number of stages is less than 15, the decision tree indicates, at leaf node 506, that the 90-day production of the proposed well is likely to be less than 25,000 barrels.

Once a leaf node of the decision tree is reached and the 90-day production bucket is determined, an actual value for 90-day production of the proposed well can be estimated. How to obtain this value will be discussed below.

If the number of stages for a proposed well is greater than or equal to 15 and less than 20, the decision tree indicates, at intermediate node 504, that further analysis is warranted. In order to determine the 90-day production bucket for proposed wells with a number of stages from this range, other input features may be considered. Particularly, a second iteration of the decision tree process described above may be performed. In this second iteration, the same buckets are used for 90-day production, depth, and pressure. However, in some cases, different sets of buckets may be used in at least some iterations.

TABLE 6
Training Well Data (Second Iteration).

| | | Initial | 90-Day |
|---|---|---|---|
| Training | Depth | Reservoir | Production |
| Well | (feet) | Pressure (PSI) | (Barrels) |
| B | 4,500 | 45 | 27,000 |
| C | 5,100 | 35 | 26,000 |
| F | 5,200 | 37 | 18,000 |

Table 6 depicts the training well data for this second iteration. The data in Table 6 is a subset of the data in Table 1. Notably, the training well entries in Table 1 that can be mapped to a 90-day production bucket by the partial decision tree of FIG. 5A have been removed. Additionally, the column representing the stimulation stages input factor has also been removed. This permits the analysis to focus on the impact that depth and pressure may have on 90-day production, so that the decision tree can be completed.

TABLE 7
90-Day Production Buckets (Second Iteration).

| 90-Day Production Buckets | Bucket Contents (Wells) | | Probability |
|---|---|---|---|
| prod ≥ 30,000 (X) | 0 | | 0 |
| 30,000 > prod ≥ 25,000 (Y) | 2 | (B, C) | 0.667 |
| 25,000 > prod (Z) | 1 | (F) | 0.333 |

Table 7 shows the 90-day production buckets for the second iteration. The entropy and Gini index for the data in this table are:

e=−0.333 log₂(0.333)−0.667 log₂(0.667)=0.923

g=1−(0.333)²−(0.667)²=0.456

Next, the entropy and Gini indexes for the depth and pressure input features may be determined.

TABLE 8
Depth Buckets (Second Iteration).

| | Bucket | | 90-Day | | |
|---|---|---|---|---|---|
| Depth | Contents | | Production | | Gini |
| Buckets | (Wells) | | Buckets | Entropy | Index |
| depth ≥ 5200 | 1 | (F) | Z | 0 | 0 |
| 5200 > depth ≥ 4700 | 1 | (C) | Y | 0 | 0 |
| 4700 > depth | 1 | (B) | Y | 0 | 0 |

Table 8 shows the contents of the depth buckets. Notably, each depth bucket contains only one well. Thus, the entropy and Gini index for all depth buckets are 0, as are the average entropy and average Gini index for the depth buckets. This suggests that depth is a good choice of an input factor for intermediate node 504 of the decision tree. However, for sake of completeness, pressure buckets are shown in Table 9.

TABLE 9
Pressure Buckets (Second Iteration).

| | Bucket | | 90-Day | | |
|---|---|---|---|---|---|
| Pressure | Contents | | Production | | Gini |
| Buckets | (Wells) | | Buckets | Entropy | Index |
| pressure ≥ 40 | 1 | (B) | Y | 0 | 0 |
| 40 > pressure | 2 | (B, C) | Y, Z | 1 | 0.5 |

One of the entries in Table 9 exhibits non-zero entropy. This establishes that depth is likely a better predictor of 90-day production than pressure. At this point, it is not necessary to calculate average entropy or average Gini index for the pressure buckets, but if these calculations were performed, the results would be as follows:

ē=1/3(0)+2/3(1)=0.667

g̅=1/3(0)+2/3(0.5)=0.333

Regardless, the decision tree can now be completed, and is shown in FIG. 5B. Particularly, intermediate node 504 was labeled to indicate that well depth is the second (and final) input factor to be considered. If the depth of a proposed well is greater than or equal to 5,200 feet, the decision tree indicates, at leaf node 508, that the 90-day production of the proposed well is likely to be less than 25,000 barrels. On the other hand, if the depth is less than 5,200 feet, the decision tree indicates, at leaf node 510, that the 90-day production of the proposed well is likely to be at least 25,000 barrels but less than 30,000 barrels.

It should be noted that only stimulation stages and depth are considered in the decision tree. This means that these two input features are estimated to have a significant influence on 90-day production, while pressure does not. This process of building the decision tree is one example of how feature selection can take place—if a feature ends up in the decision tree it is “selected” while features that do not end up in the decision tree are not selected. Thus, the decision tree of FIG. 5B represents both a feature selection technique, as well as a modeling technique. However, different feature selection and modeling techniques may be used.

TABLE 10
Proposed Well Data.

| | | | Initial | 90-Day |
|---|---|---|---|---|
| Proposed | Stimulation | Depth | Reservoir | Production |
| Well | Stages | (feet) | Pressure (PSI) | (Barrels) |
| G | 23 | 5,700 | 55 | Unknown |
| H | 17 | 4,800 | 45 | Unknown |

With the completed decision tree of FIG. 5B, the expected 90-day production of proposed wells can be estimated. Table 10 provides examples of proposed wells, including their stimulation stages, depths, and pressures.

To determine the 90-day production of proposed well G, the decision tree is traversed starting from root node 500 and using the data associated with that well. Thus, at root node 500, the number of stimulation stages of proposed well G is considered. Since this value is greater than or equal to 20, leaf node 502 is reached, and the estimated 90-day production of proposed well G is greater than or equal to 30,000 barrels.

For proposed well H, the decision tree is traversed, once again starting from root node 400. The number of stimulation stages is 17, so intermediate node 504 is reached. At intermediate node 504, the depth of proposed well H is considered. Since this value is less than 5,200 feet, leaf node 510 is reached, and the estimated 90-day production of proposed well H is at least 25,000 barrels but less than 30,000 barrels.

Since the tree's leaf nodes provide estimates of 90-day production amounts in the form of a range, it may be beneficial to estimate values within these ranges for each proposed well. One way of doing so is through linear extrapolation.

Linear extrapolation estimates the location of a particular point on the y-axis of a line graph based on the x-axis value of the particular point and the locations of other points on this graph. The following equation can be used to determine the unknown y-axis value (y₃) of a point (x₃, y₃), where x₃ and other points (x₁, y₁) and (x₂, y₂) are known:

$${y}_{3} = {y}_{1} + \frac{{x}_{3} - {x}_{1}}{{x}_{2} - {x}_{1}} ( {y}_{2} - {y}_{1} )$$

When applying linear extrapolation to the training well data set and proposed well G for leaf node 502, the x-axis may be the number of stimulation stages and the y-axis may be 90-day production. The training wells that fall into leaf node 502 are A and E. These training wells have stimulation stages values of 20 and 25, respectively, and 90-day production values of 30,000 barrels and 35,000 barrels, respectively. Plugging these values into the linear extrapolation equation results in:

$${y}_{3} = 30 \text{,} 000 + \frac{23 - 20}{25 - 20} ( 35 \text{,} 000 - 30000 ) = 33 \text{,} 000$$

Thus, the estimated 90-day production of proposed well G is 33,000 barrels.

Similarly, when applying linear extrapolation to the training well data set and proposed well H for leaf node 510, the x-axis may be depth and the y-axis may be 90-day production. The training wells that fall into leaf node 510 are B and C. These training wells have depth values of 4,500 feet and 5,100 feet respectively, and 90-day production values of 27,000 barrels and 26,000 barrels, respectively. Plugging these values into the linear extrapolation equation results in:

$${y}_{3} = 27 \text{,} 000 + \frac{4 \text{,} 800 - 4 \text{,} 500}{5 \text{,} 100 - 4 \text{,} 500} ( 26 \text{,} 000 - 27 \text{,} 000 ) = 26 \text{,} 500$$

Thus, the estimated 90-day production of proposed well H is 26,500 barrels.

The technique of linear extrapolation described above is not the only method of estimating a value for 90-day production. Other techniques, such as polynomial extrapolation and various types of regression calculations may be used as well or instead of linear extrapolation.

In some situations, it may be desirable to test the decision tree against a test set of wells in production that were not used to build the decision tree. This validation step typically occurs prior to using the model to predict the output characteristics of a proposed well.

For instance, the 90-day production values predicted by the decision tree may be compared to the actual 90-day production values exhibited by the wells in the test set. The differences between these values is considered error, and may be expressed as a total absolute error, mean squared error, root mean squared error, median error, or in some other fashion. If this error is sufficiently small (e.g., less than a particular value or less than the aggregate error produced by another model), the model may be considered validated.

Using modeling techniques such as those illustrated above in which 90-day production is predicted, multiple production predictions can be made at various time intervals. For example, a curve of predicted production could be drawn over a six month period by executing similar feature selection and statistical modeling techniques for 30, 60, 90, 120, 150, and 180 days of production. This would allow a production curve representing six different predictive data points to be drawn for a prospective well prior to any drilling activity.

Further, similar curves could be drawn representing “confidence intervals” or “prediction intervals” for that same prospective well. For instance, the same predictive model could be used to output three predicted production curves at confidence intervals of “P10” (10% confidence), “P50” (50% confidence), and “P90” (90% confidence). Cost, drilling efficiency, long term production performance potential, safety characteristics, and other factors could also be predicted using models built for those purposes. These different forms of analyses may be based on the core feature selection and predictive modeling capabilities.

While the examples above focus on an individual decision tree, multiple decision trees can be used in practice. When this happens, the ultimate prediction made by the model may be based on a weighted representation of the output of these trees.

### V. Combined Learning Model with Autoregressive Time-Series

The embodiments herein can be used to adapt the above modeling techniques to incorporate time-series data related to the operation of existing wells. Thus, the models can be used for more than just determining whether, where, and how to drill new wells—they can use actual well production data to predict proposed and existing well performance more accurately. Furthermore, these models can be used to explore counterfactual (e.g., “what if”) scenarios to understand the possible impact of anomalous events on well productivity.

In these embodiments, an autoregressive (AR) model is combined with a decision-tree-based model for purposes of illustration. Autoregressive models characterize time-series data using previous observations in the time-series as input to a regression equation. Such an equation can predict future observations in the time series. The number of previous observations can be used to parameterize the autoregressive model so that more or less dependencies on these previous observations are taken into account.

As an example, an AR(1) model considers only the most recent previous observation, and can be written as:

Xₜ=αXₜ₋₁+c

In this equation, Xₜ is the predicted observation at time t, Xₜ₋₁ is the most recent observation at time t−1, α is a gain value (usually |α|<1), and c is a constant (in some cases a Gaussian noise component may be added as well). Similarly, an AR(2) model considers only the two most recent previous observations, and can be written as:

Xₜ=α₁Xₜ₋₁+α₂Xₜ₋₂+c

In this equation, Xₜ is the predicted observation at time t, Xₜ₋₁ is the most recent observation at time t−1, Xₜ₋₂ is the second-most recent observation at time t−2, α₁ and α₂ are gain values (usually |α₁|<1 and |α₂|<1), and c is a constant.

Based on this understanding, an AR(p) model can be represented for an arbitrary p as:

Xₜ=α₁Xₜ₋₁+α₂Xₜ₋₂+ . . . αₚXₜ₋ₚc

As an example related to well production, and AR(p) model can use the most-recent p observations of well production to predict future well production. Notably, once Xₜ is determined, this model can be used in a recursive fashion to predict well production values at Xₜ₊₁, Xₜ₊₂, . . . , X_{t+q} and so on for q predictions.

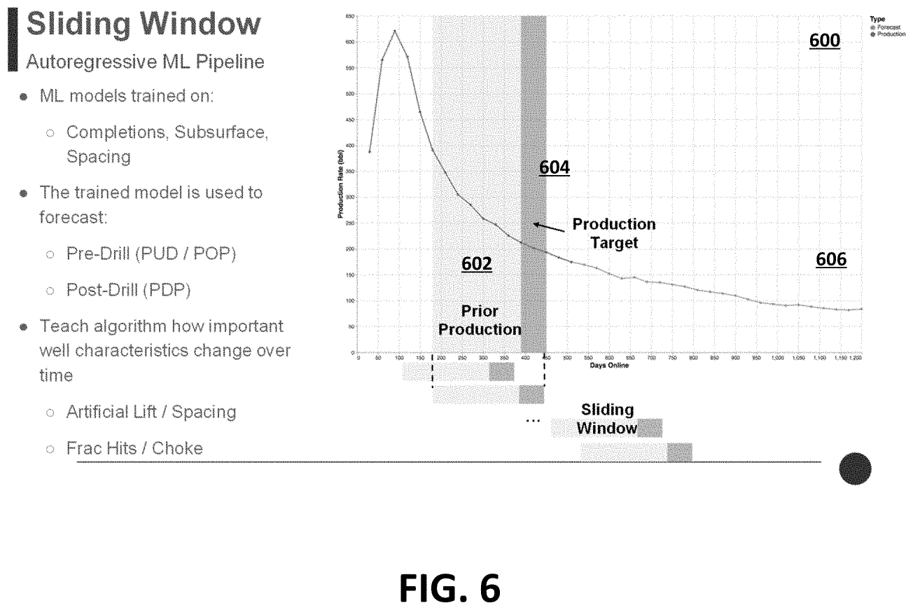

With this in mind, a combination of the learning model described above (decision-tree-based or otherwise) and an autoregressive model can be formed to take into account the time varying nature of well production. The result is a unified model that can be used to predict well production in both pre-drill scenarios (where little or no operational data is available) and post-drill scenarios (where operational data is available). The combined model can be conceptualized as a sliding window of variable size that looks back p epochs of time to make predictions for the next q epochs of time in the future. FIG. 6 depicts such a model as production graph 600. The sliding window is depicted as p epochs of prior production 602 followed by one epoch of production target 604 (predicted current production) and then q epochs of future production 606.

Using slightly different notation than was used above, an expression for this combined model is:

[ŷₜ . . . ŷ_{t+w}]=f(θ,X,ωₜ₋₁ . . . ωₜ₋ₙ)

Where t is time, n is the number of lags, w is the width of the prediction window, f is the model, θ represents the model parameters, X represents the time-independent features, ω represents the time-dependent features, and the 9 values are the predictions. When n<t, this simplifies to:

ŷₜ=f(θ,X,ωₜ₋₁ . . . ω₀)

Notably, the ŷ values are fed back into the model recursively to use as lagged production values so that production values further in the future can be predicted.

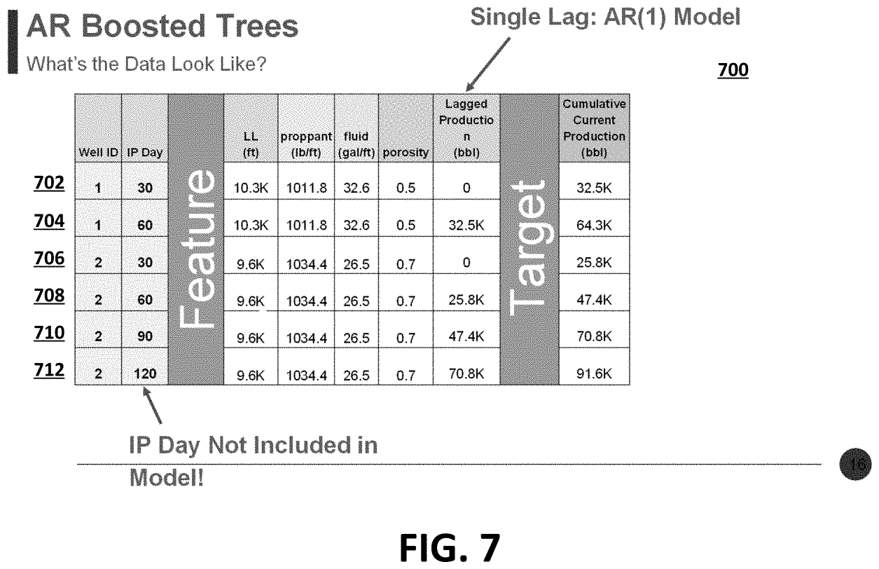

FIG. 7 provides a simple example of an AR(1) model used to enhance the predictive ability of decision trees. Table 700 includes six entries (rows) for two different wells. Entries 702 and 704 relate to well 1, and entries 706, 708, 710, and 712 relate to well 2.

Well 1 came online 30 days prior to the observation of entry 702, and table 700 includes data for the operation of well 1 at 30 and 60 days from when it came online (IP day 30 and 60, respectively). Well 2 came online 30 days prior to the observation of entry 706, and table 700 includes data for the operation of well 2 at 30, 60, 90, and 120 days from when it came online (IP day 30, 60, 90, and 120, respectively). Here IP day d refers to the dth day after initial production by the well. In these examples, IP days are recorded every 30 days, but IP days could be recorded at a different frequency (e.g., 5 days, 10 days, 15 days, 60 days, 90 days, etc.).

The features representing well operation and corresponding well production are shown in each entry of table 700. Thus, in entry 702 (representing IP day 30 of well 1), well 1 had a 10.3K ft lateral length, was pumped with 1011.8 lb/ft of proppant, was also pumped with 32.6 gal/ft of fluid, and was drilled into rock with a porosity of 0.5. These features of lateral length, proppant volume, fluid volume, and porosity are generally constant (time-independent), though in some embodiments certain features can change. Well 1 also had a lagged production of 0 (there was no recorded production for this well prior to entry 702). At this point in time, the cumulative production of well 1 was 32.5K bbl.

In entry 704 (representing IP day 60 of well 1), well 1 had a 10.3K ft lateral length, was pumped with 1011.8 lb/ft of proppant, was also pumped with 32.6 gal/ft of fluid, and was drilled into rock with a porosity of 0.5. Well 1 also had a lagged production of 32.5 bbl. This lagged production is the cumulative production of well 1 at IP day 30—in other words, entry 702 is provided as an autoregressive parameter to entry 704. At this point in time, the cumulative production of well 1 was 64.3K bbl.

In entry 706 (representing IP day 30 of well 2), well 2 had a 9.6K ft lateral length, was pumped with 1034.4 lb/ft of proppant, was also pumped with 26.5 gal/ft of fluid, and was drilled into rock with a porosity of 0.7. Well 2 also had a lagged production of 0 (there was no recorded production for this well prior to entry 706). At this point in time, the cumulative production of well 2 was 25.8K bbl.

In entry 708 (representing IP day 60 of well 2), well 2 had a 9.6K ft lateral length, was pumped with 1034.4 lb/ft of proppant, was also pumped with 26.5 gal/ft of fluid, and was drilled into rock with a porosity of 0.7. Well 2 also had a lagged production of 25.8K bbl. This lagged production is the cumulative production of well 2 at IP day 30—in other words, entry 706 is provided as an autoregressive parameter to entry 708. At this point in time, the cumulative production of well 2 was 47.4K bbl.

This trend continues in entries 710 and 712. In entry 710, the cumulative production of well 2 from entry 708 becomes the lagged production. In entry 712, the cumulative production of well 2 from entry 710 becomes the lagged production.

In this manner, autoregressive characteristics can be incorporated into the prediction model. Notably, each of the entries in table 700 may be used to train a decision-tree-based model. The input features are lateral length, proppant volume, fluid volume, porosity and lagged production, while the ground truth (labeled) output characteristic is cumulative production. With enough training data (e.g., hundreds or thousands of entries from operational wells), this model can predict the production of existing wells for post-drilling scenarios and more accurately predict the production of new wells for pre-drilling scenarios.

Further, the training, testing, and evaluation data can be split by their positions in time. Future performance can be predicted based on using only past, historical production. This can be accomplished by excluding future production for a specific well while incorporating its past production using a predefined cutoff point in time and also by excluding the entire production history for wells that do not exist before the cutoff.

Note that although FIG. 7 indicates that IP day is not used as an input feature in the model, IP day could be used as such. The embodiments herein allow virtually any time-dependent or time-independent feature to be added.

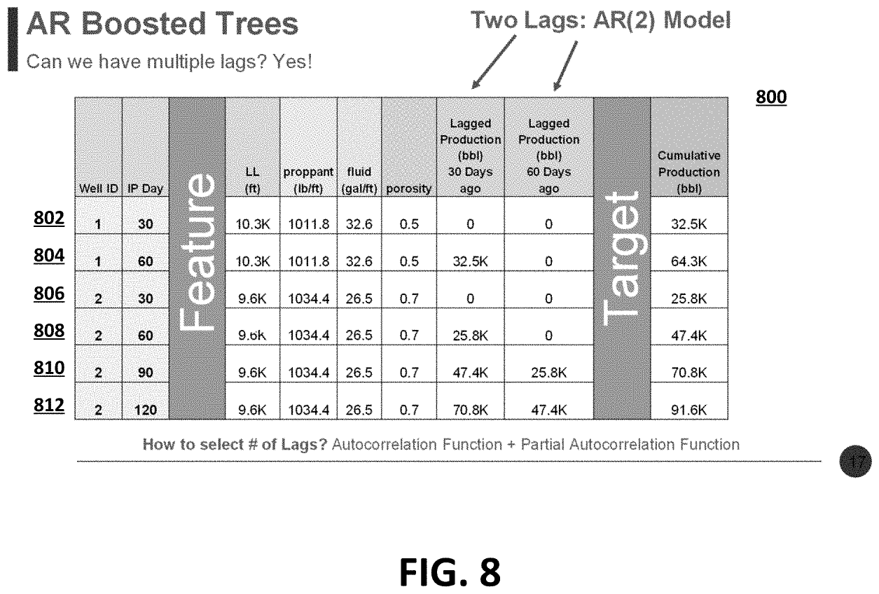

The procedures depicted in FIG. 7 can be expanded to incorporate any order of autoregressive model that the data will support. The same data is used in FIG. 8 as the basis of an AR(2) model. Table 800 is essentially identical to table 700, except that two lagged production columns are used, one for 30 days in the past and another for 60 days in the past. The column containing the lagged production for 30 days in the past is the same as the lagged production of table 700.

For both of entries 802 and 804 (corresponding to IP day 30 and 60, respectively, of well 1), the lagged production for 60 days in the past is 0 bbl. This is because the cumulative production for well 1 is not available, as well 1 was not in production at those points in time.

For entries 806, 808, 810, and 812, the lagged production 60 days in the past for well 2 is the cumulative production from 60 days prior. Thus, both of entries 806 and 808 (corresponding to IP day 30 and 60, respectively, of well 1), the lagged production for 60 days in the past is 0 bbl. This is because the cumulative production for well 2 is not available, as well 2 was not in production at those points in time. However, for entry 810, the lagged production for 60 days in the past is 25.8K bbl, as that is the cumulative production for well 2 indicated by entry 806. Likewise, for entry 812, the lagged production for 60 days in the past is 47.4K bbl, as that is the cumulative production for well 2 indicated by entry 808.

In a similar fashion AR(p) models can be supported for other values of p. Again, with enough training data, these models can predict the production of existing wells for post-drilling scenarios and more accurately predict the production of new wells for pre-drilling scenarios.

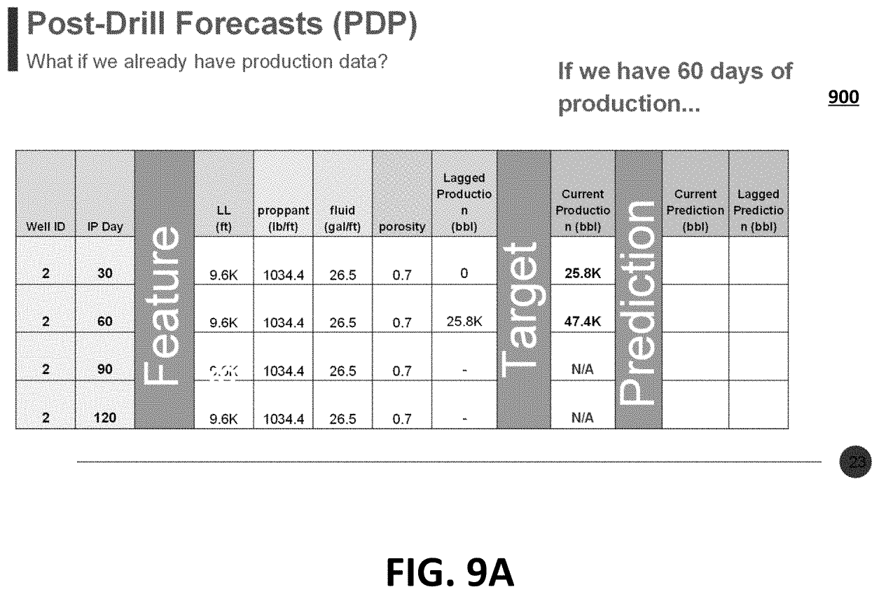

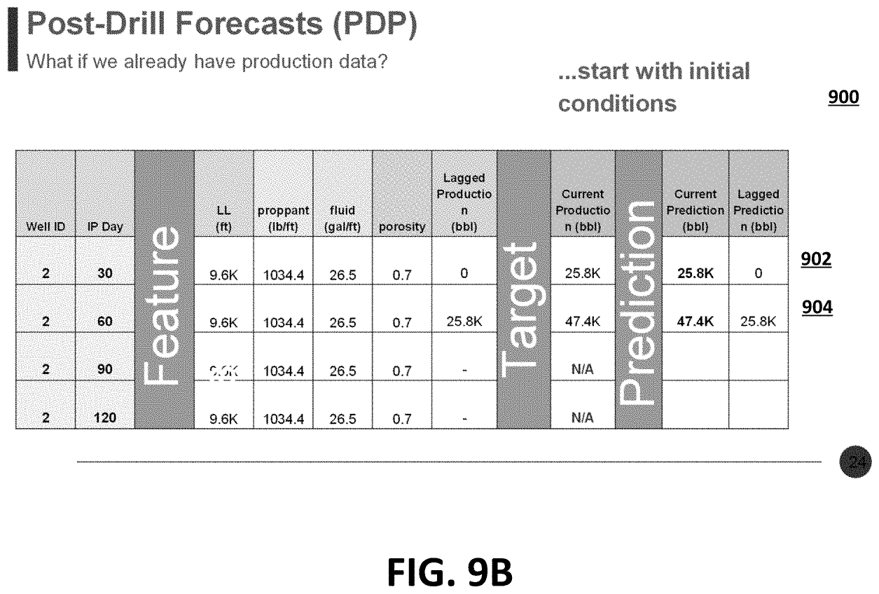

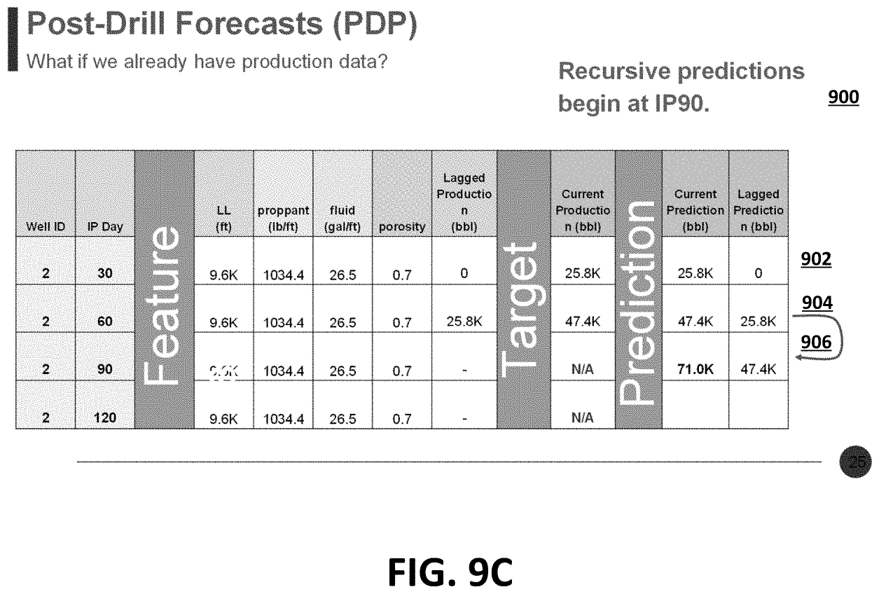

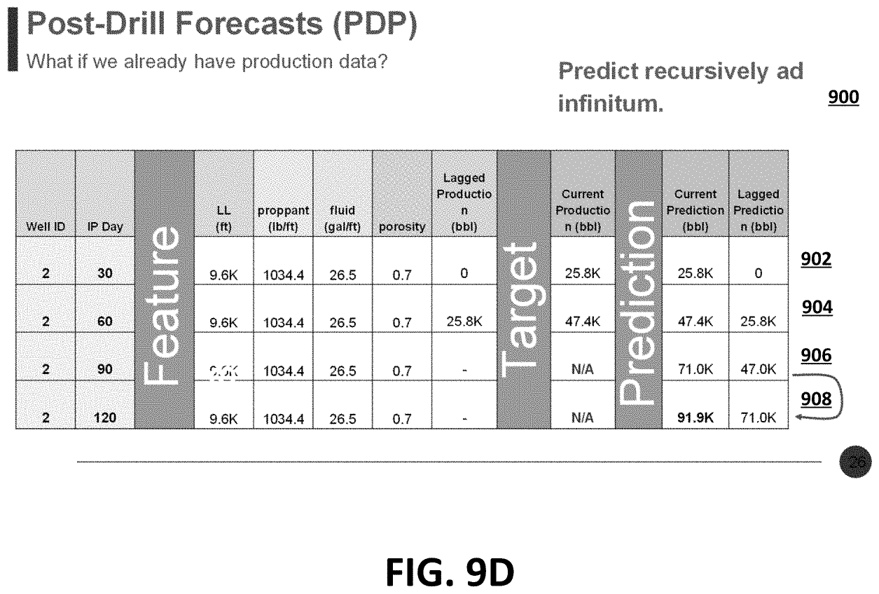

FIGS. 9A-9D depict another form of prediction that is suggested in FIG. 6 and the equations above—future prediction of well production multiple epochs in the future.

Table 900 of FIG. 9A depicts several time-independent input features and 60 days of measured well production (with snapshots at IP days 30 and 60) with lagged production used to incorporate an AR(1) model. The goal is to predict well production into the future, such as at IP days 90, 120, and beyond. In other examples, time-dependent features could be included without changing the predictive approach.

In FIG. 9B, predictions for current cumulative production and lagged production are filled out in entries 902 and 904. These values are seeded from the actual production and lagged production observations.

In FIG. 9C, predictions for current cumulative production and lagged production are filled out in entry 906. The prediction of current cumulative production is made using the model as trained with input features and ground-truth output characteristics. The prediction of lagged production is the observed production in entry 904.

In FIG. 9D, predictions for current cumulative production and lagged production are filled out in entry 908. Again, the prediction of current cumulative production is made using the model as trained with input features and ground-truth output characteristics, possibly including those of entry 906. Likewise, the prediction of lagged production is the predicted production in entry 906.

This process can continue for any number of epochs, recursively building the model to predict well production days, months, or even years in the future.

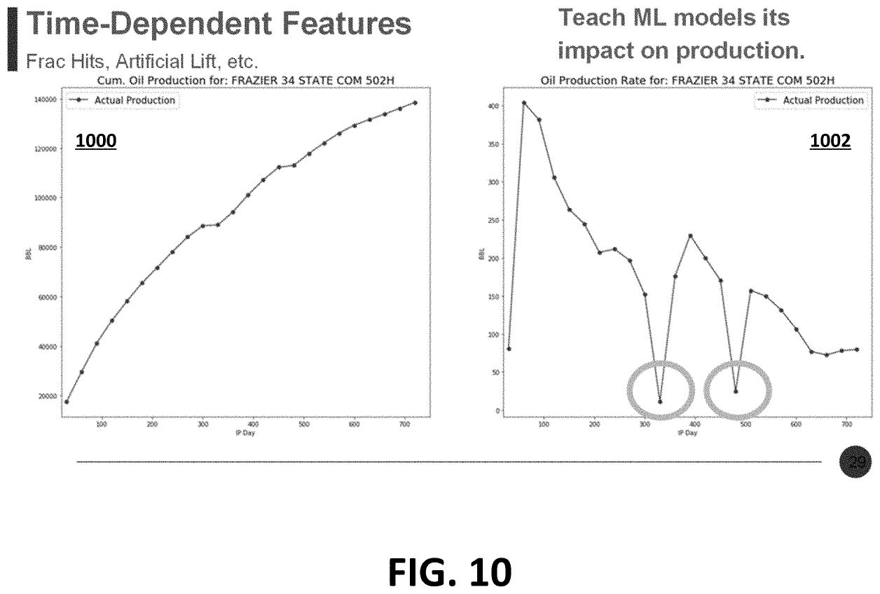

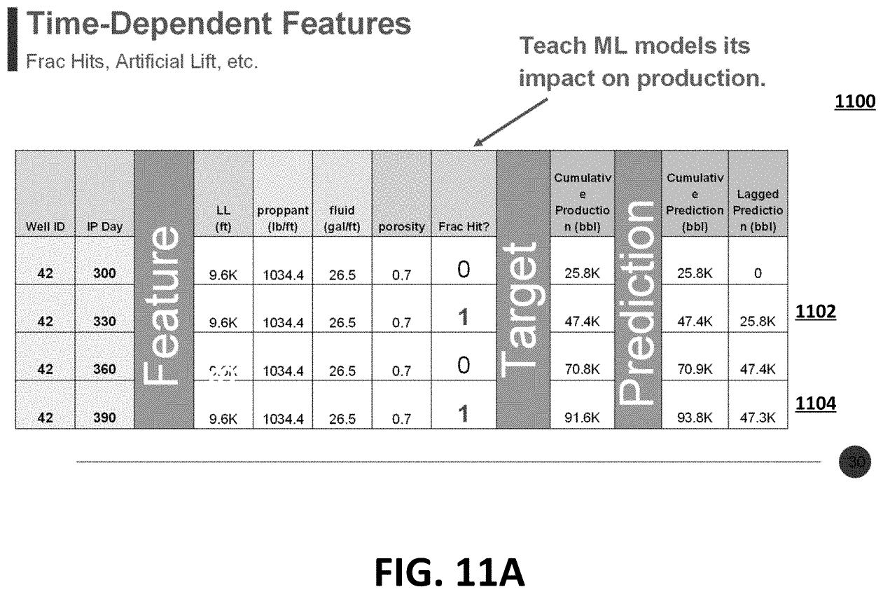

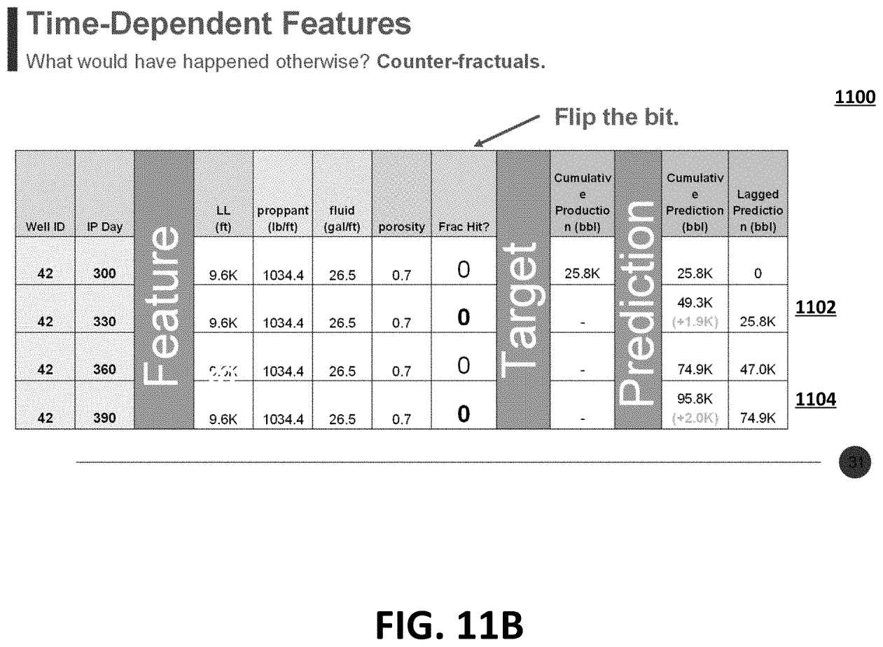

Another useful aspect of this combined modeling approach is depicted in FIGS. 10, 11A, and 11B. In particular, these figures demonstrate how the modeling techniques herein can answer “what if” questions regarding well production with and without anomalous events.

These anomalous events may be called “frac hits” for purposes of convenience, but cover any sort of random, one-time, or unexplained event that impacts well production. Thus, anomalous events may include pumping or stimulation of a nearby well, adverse weather, human error, and so on.

In FIG. 10, chart 1000 provides cumulative production for a well from approximately IP day 0 through IP day 750. Notably, there are two flat points on this curve, at about IP day 330 and IP day 480. This suggests that little or no production occurred on these days. Chart 1002 provides production rates over the same period. As expected, IP day 330 and IP day 480 show near zero production. These values may be considered to be the result of a frac hit (or other anomalous event).

A given well may experience several anomalous events per year. Well operators currently have no way to account for these events. But the models presented herein can predict two valuable scenarios: (1) how much production output was lost due to anomalous events, and (2) assuming that a certain number of anomalous events are going to occur, what would be the impact on well production.

FIG. 11A depicts table 1100 that models frac hits as a time-dependent input feature. Notably, a frac hit is represented as a Boolean value—a 1 if it occurred and a 0 if it did not. Other embodiments may involve frac hits being represented by non-Boolean values, such as an integer indicating the magnitude of the frac hit (e.g., 0, 1, 2, 3, . . . where a higher number represents a great magnitude and 0 indicates no frac hit). In table 1100, frac hits occurred in entries 1102 and 1104.

FIG. 11B depicts table 1100 in which the Boolean values representing frac hits are flipped from 1 to 0. The model is then executed using these values to determine what predicted production would have been if the frac hits had not occurred. The result, as shown in entries 1102 and 1104, is a total of 3.9K more bbl.

As noted, the converse can be used to predict the impact of frac hits. Entries in which the frac hit value is 0 can be flipped to 1, and then the model can be executed using these values. The result potentially provides a more accurate overall prediction of well production given the assumption that a certain number of frac hits are unavoidable.

If frac hits are represented as non-Boolean values, a non-zero frac hit may be “flipped” to a value of 0 while a 0 frac hit value may be “flipped” to a non-zero value (e.g., 2). Other possibilities exist.

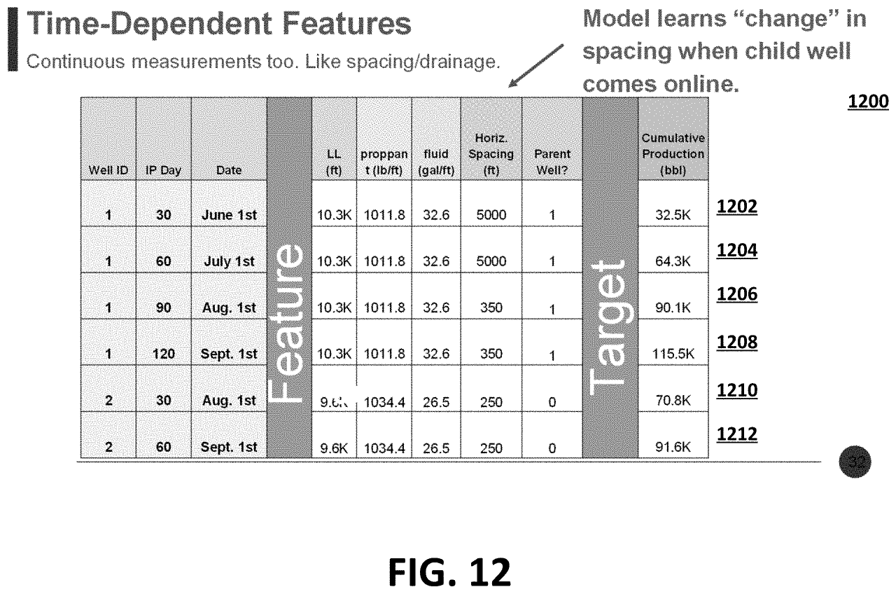

Another way of modeling time-dependent data with anomalies, but without explicitly including frac hits, is shown in FIG. 12. Two wells are represented, well 1 in entries 1202, 1204, 1206, and 1208, and well 2 in entries 1210 and 1212. Well 1 is designated as a parent well (the first well drilled or entering operation in a given area), while well 2 is designated as a child well of well 1.

In entries 1202 and 1204, well 1 is shown having a horizontal spacing of 5000 ft. This indicates that the nearest other well to well 1 is 5000 feet away. But, by August 1, nearby well 2 has come online and is in production. Thus, in entries 1206 and 1208 the horizontal spacing for well 1 is changed to 350 ft. The production rate for well 1 (as derived from the cumulative production column) is approximately 32K bbl for each of entries 1202 and 1204. But once well 2 has entered production, the production rate of well 1 drops to approximately 26K bbl in entries 1206 and 1208. This may be due to well 2 being near enough to well 1 so as to reduce the amount of reserve that can be pumped by well 1. Thus, the embodiments herein can take into account the impact of well spacing on well production, another capability that was previously unavailable.

### VI. Visualizing Model Explainability

Models with numerous input features, such as the models described herein, often suffer from a lack of explainability. In particular, when the model produces an output, it can be difficult to determine exactly which input features contributed how much to this output. In many practical scenarios, even if there are dozens of input features, a relatively small number of these (e.g., 5-15%) contribute to most of the variation in output values. Given the overall complexity of machine-learning models such as the decision trees described herein, it is beneficial to be able to identify the impact of each input feature in a fashion that can be understood by a non-technical audience.

One method of doing so is through the use of Shapley data. In short, given a particular output value of a model for a particular set of input feature values, as well as the average of this output value across all input feature values, Shapley data assigns a contribution to each of the input features. This contribution quantifies how much each input feature contributed to the difference between the particular output value and the average output value. Shapley data also capture possible inter-dependencies between input features such that the Shapley data is independent of the order in which the input features are applied (should the model be sensitive to such orderings).

With respect to the well production models described herein, the Shapley values for each input feature can be used to quantify the impact of each input feature on the difference between a particular well's predicted output and the average output of all wells. Some features may correlate with the particular well's predicted output being higher, and others may correlate with the particular well's predicted output being lower. Further, some features (in combination with other features) may correlate with one well's predicted output being higher and another well's predicted output being lower.

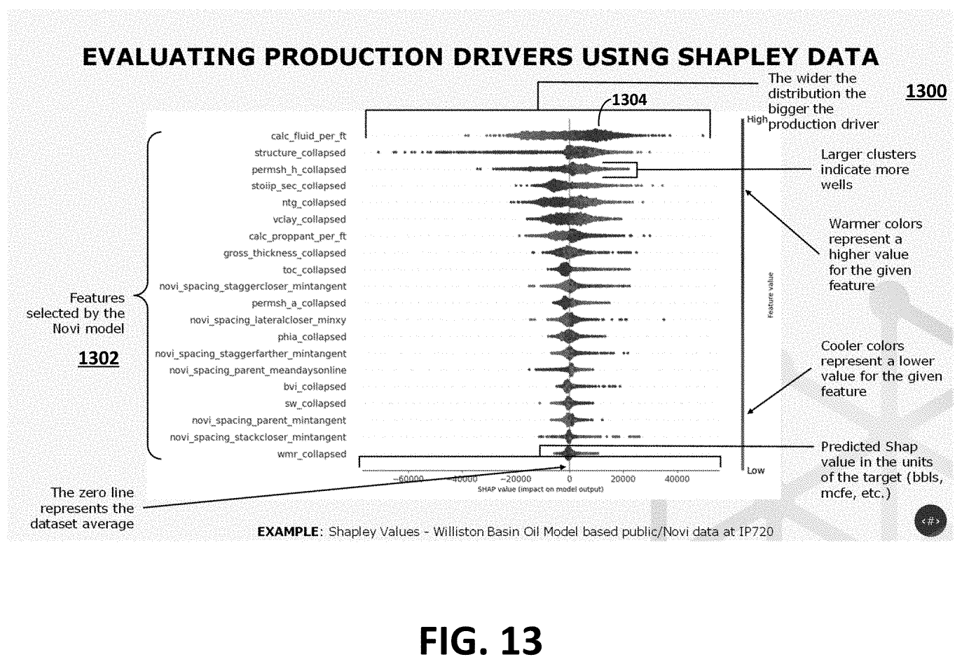

An example visualization of Shapley data is shown in graph 1300 of FIG. 13. For each of features 1302, a scatterplot is shown along a corresponding x-axis. Each value in the scatterplot corresponds to one of the wells considered by the model. The x-axis for each feature represents the difference between predicted well output and average well output, and is centered on 0. The features at the top of the chart are generally more impactful on (e.g., more highly correlated with) predicted well production than features lower in the chart. In some embodiments, the features may be sorted top to bottom in decreasing magnitude of this impact.

For example, the most impactful feature in graph 1300 is “calc_fluid_per_ft”, which is shown to be correlated with higher predicted well output in scatterplot 1304. Similar scatterplots for other features show how they positively or negatively impact well production and by approximately how much. Further, for a given well, the points representing the magnitude of deviation assigned to each feature can be highlighted.

An advantage of representing Shapley data in this fashion is that a quick glance at a graph like graph 1300 can result in a detailed understanding of why the model has predicted a specific production value for a specific well. Nonetheless, other types of graphs and visualizations of Shapley data may be possible.

### VII. Performance Results

In some possible embodiments, the techniques disclosed herein may be used to improve the selection process for determining the locations of new wells. For example, a region of land with working oil wells may be analyzed. Based on input features of these wells (e.g., location, diameter, depth, slant, lateral length, drilling equipment, stimulation, and so on), a heat map for one or more output characteristics of the wells (e.g., productivity, safety, and/or cost) may be graphically displayed. This heat map may visually represent the output parameter(s) of the wells so that locations likely to provide desirable output characteristics are differentiated from locations less likely to provide desirable output characteristics.

By automating this process, the sensitivity of the wells to numerous input parameters can be rapidly determined. Further, by analyzing the data associated with a large number of wells (e.g., tens, hundreds, thousands, etc.), this computerized technique can provide insight into relationships between input features and output characteristics that would otherwise require extensive amounts of manual labor to obtain (e.g., months, years, or more).

For instance, various additional heat maps can be produced. These additional heat maps may predict the performance of locations and wells (proposed or in production) if the input features were changed. As one possible example, a heat map could be provided that predicts the performance of proposed or existing wells in a particular set of locations if the number of stages of stimulation were increased or decreased.

As such, the techniques described herein improve the industrial process of well drilling. The impact of drilling in various locations and using numerous drilling parameters can be predicted computationally, thus reducing the cost of attempts to test the impact of such locations and parameters, which would otherwise be tested manually. Further, using the techniques described herein may result in improved production, lowered cost, and/or improved safety for wells that are drilled in accordance with at least some of the predictions models.

For areas with wells in production, heat maps can be generated to indicate the sensitivity of wells to the nearby placement of other wells or frac hits to nearby wells. For these and other reasons, the embodiments herein can also be used to improve the production of wells in existence.

In another possible scenario, an operator may observe a prediction of GOR, and conclude that it is rising faster than is desirable. A similar scenario might be where a prediction of the pressure in the well decreasing faster than is desirable. The operator could intervene by changing the choke or lift on the well, hoping to keep oil production closer to their target production over the long term life of the well.

### VIII. Example Operations

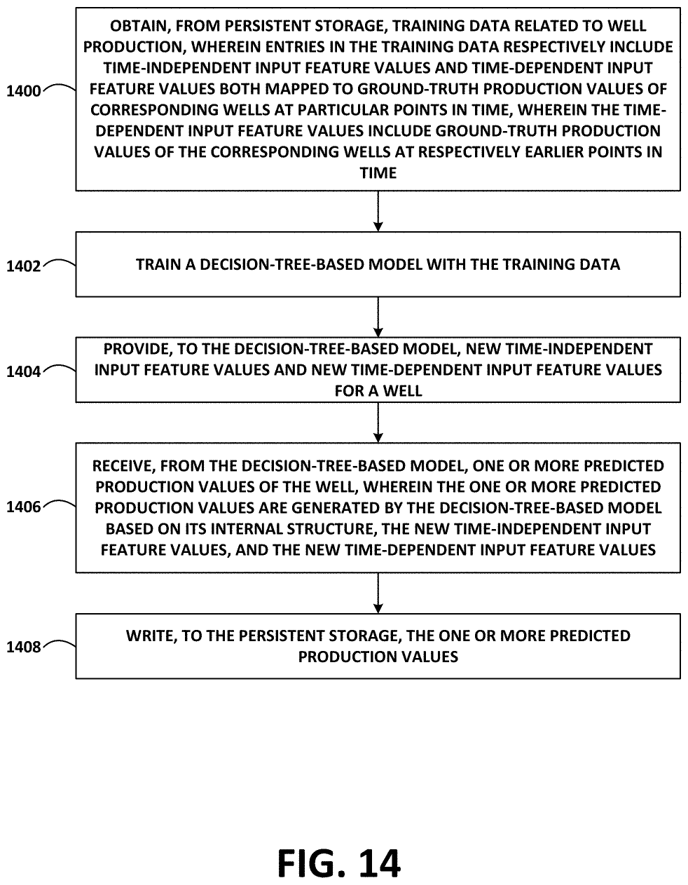

FIG. 14 is a flow chart illustrating an example embodiment. The process illustrated by FIG. 14 may be carried out by a computing device, such as computing device 200, and/or a cluster of computing devices, such as server cluster 304. However, the process can be carried out by other types of devices or device subsystems. For example, the process could be carried out at least in part by a portable computer, such as a laptop or a tablet device.

The embodiments of FIG. 14 may be simplified by the removal of any one or more of the features shown therein. Further, these embodiments may be combined with features, aspects, and/or implementations of any of the previous figures or otherwise described herein.

Block 1400 may involve obtaining, from persistent storage, training data related to well production, wherein entries in the training data respectively include time-independent input feature values and time-dependent input feature values both mapped to ground-truth production values of corresponding wells at particular points in time, wherein the time-dependent input feature values include ground-truth production values of the corresponding wells at respectively earlier points in time.

Block 1402 may involve training a decision-tree-based model with the training data.

Block 1404 may involve providing, to the decision-tree-based model, new time-independent input feature values and new time-dependent input feature values for a well.

Block 1406 may involve receiving, from the decision-tree-based model, one or more predicted production values of the well, wherein the one or more predicted production values are generated by the decision-tree-based model based on its internal structure, the new time-independent input feature values, and the new time-dependent input feature values.

Block 1408 may involve writing, to the persistent storage, the one or more predicted production values.

In some embodiments, the time-independent input feature values relate to lateral lengths of the corresponding wells, proppant pumped into the corresponding wells, fluid pumped into the corresponding wells, or porosity of rock in which the corresponding wells are respectively disposed.

In some embodiments, the time-dependent input feature values include inter-well spacing values, artificial lift, choke, pressure, or whether the corresponding wells are parent wells.

In some embodiments, the ground-truth production values represent volumes of hydrocarbons or water extracted from the corresponding wells.

In some embodiments, the ground-truth production values of the corresponding wells at respectively earlier points in time are data that can form a basis of an order 1 autoregressive model.

In some embodiments, the ground-truth production values of the corresponding wells at respectively earlier points in time are data that can form a basis of an order 2 autoregressive model.

Some embodiments may involve recursively generating further predicted production values of the well from: (i) ground-truth initial production values of the well, and (ii) the predicted production values of the well.

In some embodiments, the particular points in time are regular intervals. In some embodiments, the regular intervals are 5 days, 10 days, 15 days, 60 days, or 90 days.

In some embodiments, the time-dependent input feature values include anomalous events.

Some of these embodiments may involve: receiving indications of one or more of the anomalous events to remove from the time-dependent input feature values; generating a variation of the time-dependent input feature values with the one or more of the anomalous events removed; providing, to the decision-tree-based model, the new time-independent input feature values and the variation of the new time-dependent input feature values for the well; and receiving, from the decision-tree-based model, one or more counterfactual predicted production values of the well, wherein the one or more counterfactual predicted production values are generated by the decision-tree-based model based on its internal structure, the new time-independent input feature values, and the variation of the new time-dependent input feature values.

Some of these embodiments may involve: receiving indications of one or more hypothetical anomalous events to add to the time-dependent input feature values; generating a variation of the time-dependent input feature values with the one or more of the hypothetical anomalous events; providing, to the decision-tree-based model, the new time-independent input feature values and the variation of the new time-dependent input feature values for the well; and receiving, from the decision-tree-based model, one or more counterfactual predicted production values of the well, wherein the one or more counterfactual predicted production values are generated by the decision-tree-based model based on its internal structure, the new time-independent input feature values, and the variation of the new time-dependent input feature values.

Some of these embodiments may involve: determining Shapley data for the time-independent input feature values and the time-dependent input feature values, wherein the Shapley data indicate correlations between: (i) each of the time-independent input feature values and the time-dependent input feature values, and (ii) the ground-truth production values of the corresponding wells; generating a representation of a graphical user interface for the Shapley data, wherein each of the time-independent input feature values and the time-dependent input feature values is associated with a scatterplot of its Shapley data for the corresponding wells; and transmitting, to a client device, the representation of the graphical user interface.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing training data related to well production, wherein entries in the training data respectively include time-independent input feature values and time-dependent input feature values both mapped to ground-truth production values of corresponding wells at particular points in time, wherein the time-dependent input feature values include ground-truth production values of the corresponding wells at respectively earlier points in time; and
one or more processors configured to:
obtain, from the persistent storage, the training data;
train a decision-tree-based model with the training data;
provide, to the decision-tree-based model, new time-independent input feature values and new time-dependent input feature values for a well;
receive, from the decision-tree-based model, one or more predicted production values of the well, wherein the one or more predicted production values are generated by the decision-tree-based model based on its internal structure, the new time-independent input feature values, and the new time-dependent input feature values; and
write, to the persistent storage, the one or more predicted production values.

2. The system of claim 1, wherein the time-independent input feature values relate to lateral lengths of the corresponding wells, proppant pumped into the corresponding wells, fluid pumped into the corresponding wells, or porosity of rock in which the corresponding wells are respectively disposed.

3. The system of claim 1, wherein the time-dependent input feature values include inter-well spacing values, artificial lift, choke, pressure, or whether the corresponding wells are parent wells.

4. The system of claim 1, wherein the ground-truth production values represent volumes of hydrocarbons or water extracted from the corresponding wells.

5. The system of claim 1, wherein the ground-truth production values of the corresponding wells at respectively earlier points in time are data that can form a basis of an order 1 autoregressive model.

6. The system of claim 1, wherein the ground-truth production values of the corresponding wells at respectively earlier points in time are data that can form a basis of an order 2 autoregressive model.

7. The system of claim 1, wherein the one or more processors are further configured to:
recursively generate further predicted production values of the well from: (i) ground-truth initial production values of the well, and (ii) the predicted production values of the well.

8. The system of claim 1, wherein the particular points in time are regular intervals.

9. The system of claim 8, wherein the regular intervals are 5 days, 10 days, 15 days, 60 days, or 90 days.

10. The system of claim 1, wherein the time-dependent input feature values include anomalous events.

11. The system of claim 10, wherein the one or more processors are further configured to:
receive indications of one or more of the anomalous events to remove from the time-dependent input feature values;
generate a variation of the time-dependent input feature values with the one or more of the anomalous events removed;
provide, to the decision-tree-based model, the new time-independent input feature values and the variation of the new time-dependent input feature values for the well; and
receive, from the decision-tree-based model, one or more counterfactual predicted production values of the well, wherein the one or more counterfactual predicted production values are generated by the decision-tree-based model based on its internal structure, the new time-independent input feature values, and the variation of the new time-dependent input feature values.

12. The system of claim 10, wherein the one or more processors are further configured to:
receive indications of one or more hypothetical anomalous events to add to the time-dependent input feature values;
generate a variation of the time-dependent input feature values with the one or more of the hypothetical anomalous events;
provide, to the decision-tree-based model, the new time-independent input feature values and the variation of the new time-dependent input feature values for the well; and
receive, from the decision-tree-based model, one or more counterfactual predicted production values of the well, wherein the one or more counterfactual predicted production values are generated by the decision-tree-based model based on its internal structure, the new time-independent input feature values, and the variation of the new time-dependent input feature values.

13. The system of claim 1, wherein the one or more processors are further configured to:
determine Shapley data for the time-independent input feature values and the time-dependent input feature values, wherein the Shapley data indicate correlations between: (i) each of the time-independent input feature values and the time-dependent input feature values, and (ii) the ground-truth production values of the corresponding wells;
generate a representation of a graphical user interface for the Shapley data, wherein each of the time-independent input feature values and the time-dependent input feature values is associated with a scatterplot of its Shapley data for the corresponding wells; and
transmit, to a client device, the representation of the graphical user interface.

14. A computer-implemented method comprising:
obtaining, from persistent storage, training data related to well production, wherein entries in the training data respectively include time-independent input feature values and time-dependent input feature values both mapped to ground-truth production values of corresponding wells at particular points in time, wherein the time-dependent input feature values include ground-truth production values of the corresponding wells at respectively earlier points in time;
training a decision-tree-based model with the training data;
providing, to the decision-tree-based model, new time-independent input feature values and new time-dependent input feature values for a well;
receiving, from the decision-tree-based model, one or more predicted production values of the well, wherein the one or more predicted production values are generated by the decision-tree-based model based on its internal structure, the new time-independent input feature values, and the new time-dependent input feature values; and
writing, to the persistent storage, the one or more predicted production values.

15. The computer-implemented method of claim 14, wherein the time-independent input feature values relate to lateral lengths of the corresponding wells, proppant pumped into the corresponding wells, fluid pumped into the corresponding wells, or porosity of rock in which the corresponding wells are respectively disposed.

16. The computer-implemented method of claim 14, wherein the time-dependent input feature values include inter-well spacing values, artificial lift, choke, pressure, or whether the corresponding wells are parent wells.

17. The computer-implemented method of claim 14, wherein the ground-truth production values represent volumes of hydrocarbons or water extracted from the corresponding wells.

18. The computer-implemented method of claim 14, further comprising:
recursively generating further predicted production values of the well from: (i) ground-truth initial production values of the well, and (ii) the predicted production values of the well.

19. The computer-implemented method of claim 14, wherein the time-dependent input feature values include anomalous events, the method further comprising:
receiving indications of one or more of the anomalous events to remove from the time-dependent input feature values;
generating a variation of the time-dependent input feature values with the one or more of the anomalous events removed;
providing, to the decision-tree-based model, the new time-independent input feature values and the variation of the new time-dependent input feature values for the well; and
receiving, from the decision-tree-based model, one or more counterfactual predicted production values of the well, wherein the one or more counterfactual predicted production values are generated by the decision-tree-based model based on its internal structure, the new time-independent input feature values, and the variation of the new time-dependent input feature values.

20. An article of manufacture including a non-transitory computer-readable medium, having stored thereon program instructions that, upon execution by a computing system, cause the computing system to perform operations comprising:
obtaining, from persistent storage, training data related to well production, wherein entries in the training data respectively include time-independent input feature values and time-dependent input feature values both mapped to ground-truth production values of corresponding wells at particular points in time, wherein the time-dependent input feature values include ground-truth production values of the corresponding wells at respectively earlier points in time;
training a decision-tree-based model with the training data;
providing, to the decision-tree-based model, new time-independent input feature values and new time-dependent input feature values for a well;
receiving, from the decision-tree-based model, one or more predicted production values of the well, wherein the one or more predicted production values are generated by the decision-tree-based model based on its internal structure, the new time-independent input feature values, and the new time-dependent input feature values; and
writing, to the persistent storage, the one or more predicted production values.
